(19) United States
(12) Patent Application Publication
(10) Pub. No.: US 2014/0298957 A1
(43) Pub. Date: Oct. 9, 2014

(54) Folding Dual Ratchet Wrench (FDR Wrench)

(71) Applicant: Gary Dean Ragner, Gainesville, FL (US)

(72) Inventor: Gary Dean Ragner, Gainesville, FL (US)

(21) Appl. No.: 14/350,357

(22) PCT Filed: Oct. 25, 2012
(86) PCT No.: PCT/US12/61947

§ 371 Date: Apr. 7, 2014

Related U.S. Application Data
(60) Provisional application No. 61/628,143, filed on Oct. 25, 2011.

(51) Int. Cl. B25B 13/46

(52) U.S. Cl. CPC B25B 13/46
USPC 81/60

(57) ABSTRACT

A hand wrench comprising a center handle (251) with two ratchet wrench heads (270 and 280) pivotally connected at each end of the center handle, with each ratchet wrench designed for attachment of a multi-size drive socket, wherein each ratchet heads have at last three functional position where each ratchet head comprises a stowed position where the ratchet and drive socket are in a stowed position where the user can place the wrench in their pocket, an operational position where the ratchet and drive socket are used as a ratchet and drive socket, and a handle position where the ratchet and drive socket operate as a handle.

### CROSS-REFERENCE TO RELATED APPLICATIONS

This utility application claims priority from U.S. Provisional application Ser. No. 60/628,143, filed on Oct. 25, 2012, titled: “Folding Dual Ratchet Wrench” to the Applicant.

### BACKGROUND OF INVENTION

The field of this invention relates to ratchet wrenches that comprise a ratchet mechanism for operation with socket drivers for turning fasteners, such as, nuts, screws, bolts and the like, and more specifically to dual ratchet head designs.

The present state of socket wrenches for use with drive sockets (sockets) is very diverse and normally come with a ratchet mechanism on the wrench to allow ergonomic use of the wrench. Most American homes have at least one ratchet wrench and socket driver set in their home. Prior art includes a multitude of ways to achieve the use of drive sockets (sockets) and ratchet functions, which includes both internal and external ratchet mechanisms. Ratchet wrenches come in one of two general categories: 1) a single direction ratchet mechanisms and 2) a reversible ratchet mechanisms for bidirectional operation. Both categories are workable with the presented invention. Also, prior art ratchet wrenches often define a pivotal end so that the ratchet head and socket may be angled with respect to the ratchet handle to turn rotary fastener (bolt heads, Screw heads, Nuts, and etc.) at awkward angles. This pivotal end can also have a locking mechanism to lock the ratchet head at a particular angles with respect to the wrench handle. Nearly any prior art locking mechanism for pivotal ratchet heads can be used with all the disclosed dual ratchet wrench examples.

The disclosed invention provides a pivotal ratchet head on both ends of the wrench's center handle to allow folding of the wrench while drive sockets (sockets) are still attached to the wrench. Each pivotal ratchet head is designed for attachment to a drive socket to provide the multiple wrench configurations (positions) disclosed here. However, preferably the drive socket is designed to provide multiple socket sizes (hereafter referred to as multi-socket or multisocket) so that a full ratchet and socket set is created that can fit in a user's pocket. The disclosed invention provides a pivot joint between the center handle and each of the ratchet heads to allow the ratchet wrench and sockets to fold into a substantial more compact configuration for storage. Each pivot joint may include a locking mechanism. Many multisocket designs exist in the prior art that provide multiple socket sizes in a single socket. Each of these prior art multisockets as well as single sized drive sockets can work with the disclosed folding dual ratchet wrench.

### SUMMARY

The disclosed Folding Dual Ratchet Wrench for the first time allows users to have a full socket set and ratchet wrench in one compact tool. The invention of multisockets, where one socket can provide multiple socket sizes allows a set of two complimentary sized multisocket to provide a full range of sizes for the user. While one multisocket is useful and can provide the full range of socket sizes, (i.e. 3/16 inch to ¾ inch) the larger ¾ inch socket must still fit in and around a 3/16 inch bolt head or nut in order to use the multisocket. This is a significant difference in size and the ¾ inch socket will often be unable to fit in areas that use a 3/16 inch bolt head, nut or screw head. By using two sockets to provide all the sizes, the exterior of each socket is more closely matched to the smallest sizes for that socket (i.e. socket A=¾ to 7/16 inch sizes, socket B=½ to 3/16 inch sizes. In this way the socket exterior is more likely to be able to reach the bolt, nut or screw in its size range.

In the disclosed pivotally mounted dual ratchet wrench, many configurations are possible for the wrench. Each ratchet head is pivotally mounted so that it can fold into a compact shape for carrying. These pivotal mounts also allow the wrench to configure to many different shapes for different situations. Generally, each ratchet head can provide five distinct functional positions for each attached multisocket: 1) a stowed position, 2) a socket use position, 3) a handle position, and in many designs, 4) a crank handle position, and 5) a screw driver position. Each of these distinct functional modes can have several different angled position for each ratchet head that allow these functions. However, the crank handle function and the stowed function in most wrench examples in this patent only has one position for both ratchet heads.

### OBJECTIVES AND ADVANTAGES

Accordingly, several objects and advantages of my invention are:
a) To provide a multisocket ratchet wrench set that can fold to a very compact state.
b) To provide a multisocket ratchet wrench set where all the sockets are permanently attached to the wrench so that the sockets can never be separated from the set.
c) To provide a dual ratchet wrench that provides configurations for the ratchet head such that an attached socket has at least one stowed socket position, at least one operational socket position, and at least one handle position (grip handle).
d) To provide a ratchet wrench with a permanently attached multisocket set (i.e. 5/16 to 11/16 inch or ⅜ to 13/16 inch) where the multisockets are permanently attached to the ratchet head so they cannot be separated from the wrench.
e) To provide a double pivotal ratchet wrench that provides three functional configurations for each ratchet head and attached multisocket, comprising 1) a stowed configuration, 2) a socket use configuration, and 3) a handle configuration [Examples: all disclosed wrenches].
f) To provide a dual pivotal ratchet wrench that provides five functional configurations for the wrench and attached multisocket, comprising 1) a stowed configuration, 2) a short handle configuration, 3) a long handle configuration, 4) a screwdriver configuration, and 5) a socket extension configuration [Examples: all disclosed wrenches].
g) To provide a dual pivotal ratchet wrench with non-planar stowage that provides five functional configurations and the wrench for attached multisocket, comprising 1) a stowed configuration, 2) a short handle configuration, 3) a long handle configuration, 4) a screwdriver configuration, and 5) a socket extension configuration [Examples: wrench 300].
h) To provide a dual pivotal ratchet wrench with stowage on one side that provides five functional configurations for the wrench for attached multisocket, comprising 1) a stowed configuration, 2) a short handle configuration, 3) a long handle configuration, 4) a screwdriver configuration, and 5) a socket extension configuration [Examples: wrenches 50 and 200].
i) To provide a dual pivotal ratchet wrench with centered pivots on the ratchets that provides eight functional configurations for the wrench and attached multisocket, comprising 1) a stowed configuration, 2) a short handle configuration, 3) a long handle configuration, 4) a pistol grip handle configuration, 5) a crank handle configuration, 6) a screwdriver configuration, 7) a horizontal handle driver configuration, and 8) a socket extension configuration [Examples: wrench 350].
j) To provide a dual pivotal ratchet wrench with non-planar stowage that provides eight functional configurations for the wrench and attached multisocket, comprising 1) a stowed configuration, 2) a short handle configuration, 3) a long handle configuration, 4) a pistol grip handle configuration, 5) a crank handle configuration, 6) a screwdriver configuration, 7) a horizontal handle driver configuration, and 8) a socket extension configuration [Examples: wrenches 400, 450, and 550].
k) To provide a dual pivotal ratchet wrench that provides eight functional configurations for the wrench and attached multisocket, comprising 1) a stowed configuration, 2) a short handle configuration, 3) a long handle configuration, 4) a pistol grip handle configuration, 5) a crank handle configuration, 6) a screwdriver configuration, 7) a horizontal handle driver configuration, and 8) a socket extension configuration [Examples: wrenches 100, 150, 250, 350, 400, 450, 500, and 550].
l) To provide a dual pivotal ratchet wrench that includes a center handle that folds along a pivotal hinge.

### DEFINITIONS

driver size—a wrench connector size, which has standard square connector sizes of one-quarter inch (¼″), three-eighths inch (⅜″), and one-half inch (½″). Other larger sizes and passthrough drive connectors also exist for connecting the appropriate sockets.

deep-well-sized socket—a socket having a standard longitudinal length for a deep-well socket of a particular driver size. The longitudinal length of deep well sockets varies slightly from manufacture to manufacture, but is approximately 2.5 inches for ⅜ inch drive sockets, and approximately 3.0 inches for ½ inch drive sockets.

longitudinally overlapped sockets—where two sockets are relatively aligned (near parallel) and at least a portion of the two sockets are side by side and/or overlap each other (see longitudinally overlapped socket positions 61a and 66a in FIG. 3B, socket positions 62a and 67a in FIG. 3C, sockets 61 and 66 shown in FIGS. 4A-B, sockets 62 and 67 in FIG. 4C, sockets 61 and 66 in FIG. 5B, sockets 62 and 67 in FIGS. 6B and 7B, sockets 510 and 515 in FIG. 8A, Sockets 560 and 565 in FIG. 8B, and sockets 60 and 65 in FIGS. 9A-C).

ratchet head—the end portion of a ratchet wrench comprising a ratchet housing, a ratchet mechanism, and socket connector for attaching a drive socket. For the pivotal ratchet heads disclosed in this document, the entire pivotal head portion of the ratchet can be considered the ratchet head since the pivotal connector on these ratchets are so short. Ratchet heads where the socket is permanently attached to the ratchet head, a portion of the socket inside the ratchet head can also be part of the ratchet mechanism.

center handle—the handle connecting the two pivotal ratchet heads in the disclosed folding dual ratchet wrench examples.

grip handle—a temporary wrench handle formed for the user on a folding dual ratchet wrench by the combination of positions of the pivotal ratchet heads and their attached socket.

maximum dimension—largest overall dimension of a dual ratchet wrench in its stowed position. Usually measured between the furthest extremes of the two ratchet heads. For example, the maximum dimension for ratchet wrench 350 seen in its stowed position in FIG. 5B would be the measured distance between the left most portion of ratchet housing 371 and the right most portion of ratchet housing 381, but could be from bottom of multisocket 61 to the top of multisocket 66 if either multisocket were slightly longer, or center handle 351 slightly shorter.

### DRAWING FIGURES

FIG. 1A Side view of folding dual ratchet wrench with two reversible ratchet heads that have socket connectors that face the same direction when extended (positions ending in “c” in drawings).

FIG. 1B Side view of folding dual ratchet wrench with two reversible ratchet heads that have socket connectors that face opposite directions when extended (positions ending in “c” in drawings).

FIG. 1C Side view of folding dual ratchet wrench with two reversible ratchet heads with socket connector on the both sides of each ratchet head.

FIG. 2A Top view of folding dual ratchet wrench in FIG. 1A

FIG. 2B Top view of folding dual ratchet wrench in FIG. 1B

FIG. 2C Top view of folding dual ratchet wrench in FIG. 1C

FIG. 3A Operational view of folding dual ratchet wrench in FIG. 1A

FIG. 3B Operational view of folding dual ratchet wrench in FIG. 1B

FIG. 3C Operational view of folding dual ratchet wrench in FIG. 1C

FIG. 4A Side view of folding dual ratchet wrench with standard socket connector. Ratchet heads fold the multisockets on the same side of the center handle with one multisocket overlapping the other multisockets.

FIG. 4B Side view of folding dual ratchet wrench with standard socket connector on the both sides of each ratchet head, and shaped center handle.

FIG. 4C Side view of folding dual ratchet wrench with ratchet pivot axises that are not in the same plane.

FIG. 5A Side view of folding dual ratchet wrench with center pivot ratchet heads and offset center handle.

FIG. 5B Top view of folding dual ratchet wrench in FIG. 5A in operational position (multisockets not shown).

FIG. 5C Top view of pivotal ratchet head with pivot posts on extended housing for offsetting a multisocket from the center handle.

FIG. 6A Top view of folding dual ratchet wrench with two offset ratchet heads.

FIG. 6B Side view of folding dual ratchet wrench in FIG. 6A in folded position.

FIG. 7A Top view of folding dual ratchet wrench with one offset ratchet head.

FIG. 7B Side view of folding dual ratchet wrench in FIG. 7A in folded position.

FIG. 8A Side view of folding dual ratchet wrench with two permanently mounted multisockets that fold parallel when stowed.

FIG. 8B Side view of folding dual ratchet wrench with two offset ratchet heads, each including a permanently mounted multisockets.

FIG. 9A Side view of folding dual ratchet wrench 600 with a folding center handle.

FIG. 9B-C Top view and end view, respectively of folding dual ratchet wrench 620 with a scissor-style folding center handle.

FIG. 9D Side view of folding dual ratchet wrench 640 with telescoping center handle.

### DETAILED DESCRIPTION OF THE INVENTION

All of the ratchet wrenches disclosed in this patent would generally be made of a hardened metal or metal alloy such as high carbon steel, chrome vanadium steel, and stainless steel. There is no limitation to just metals or to just steel alloys. Composite materials such as carbon fiber composites are possible alternatives. Similarly, strong metals like titanium and its alloys can be used to make the disclosed ratchet wrenches. For manufacturing practicality many such wrench tools are made of lower melting point steels that can be heat treated to harden and also strengthen the steel after being formed and machined into the wrench and ratchet head shapes. Chrome vanadium steel is popular for wrenches and sockets because of its combination of relatively inexpensive cost, high strength and corrosion resistance. Standard tool manufacturing techniques can be used to construct the disclosed wrenches.

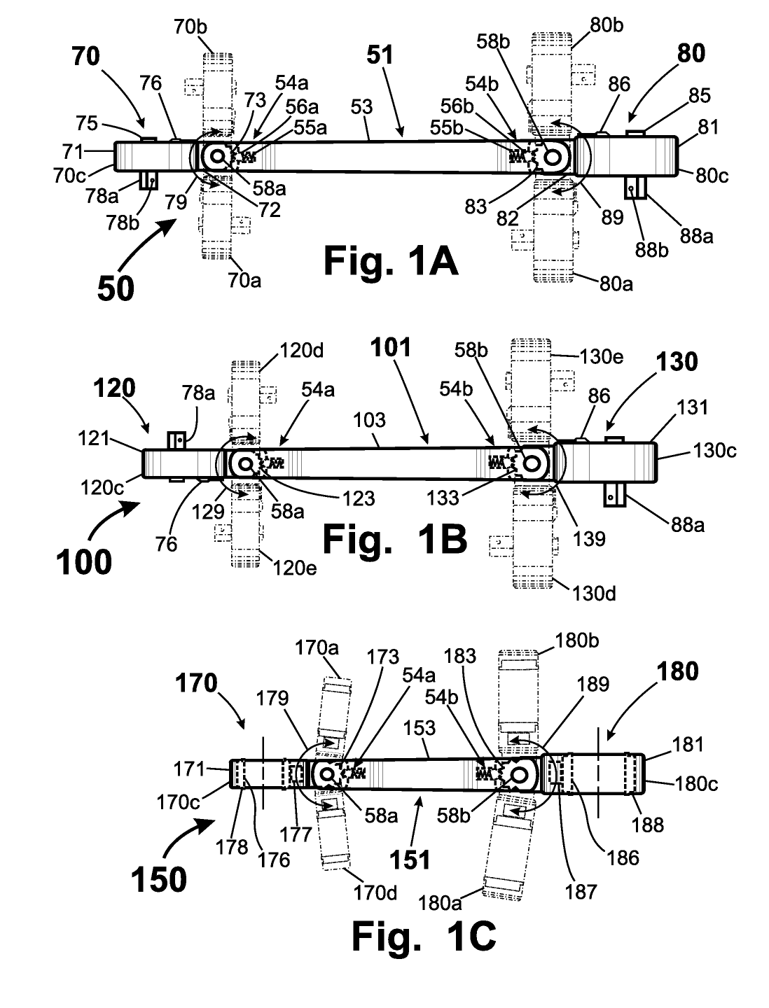

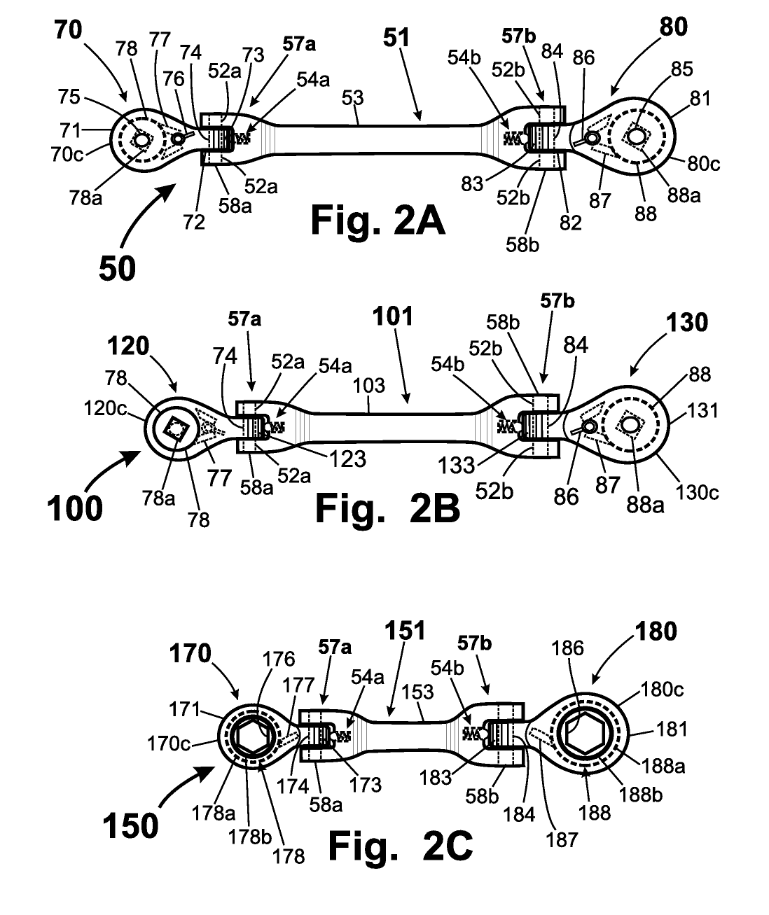

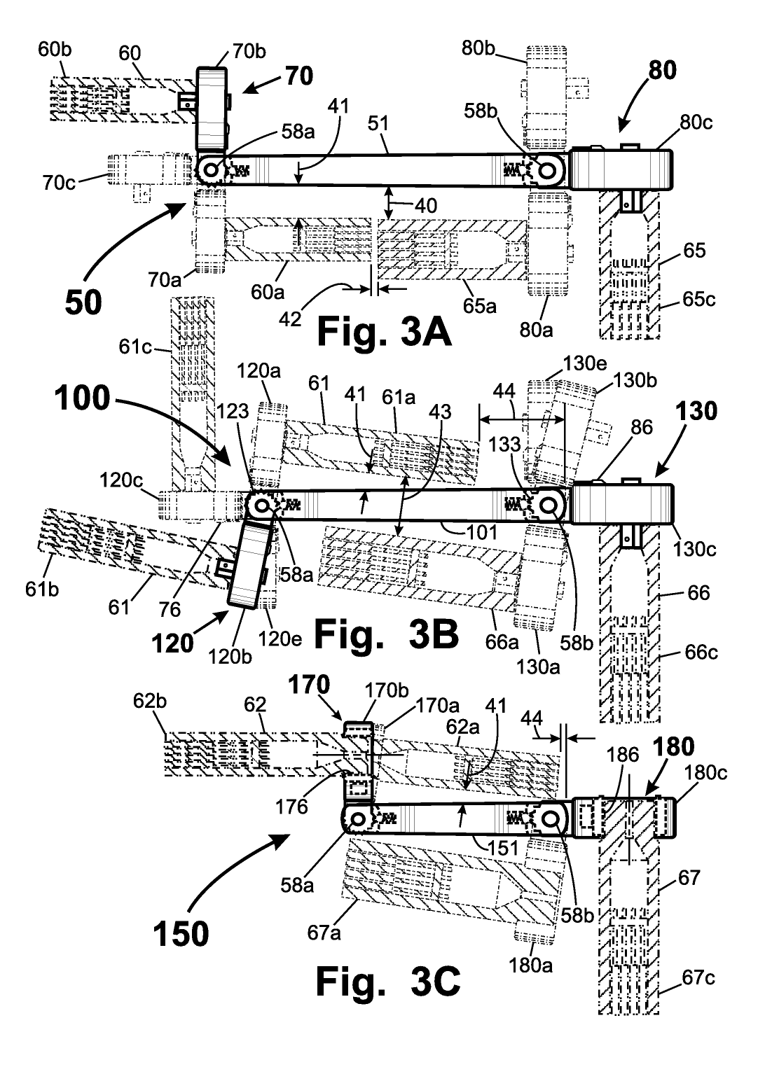

In FIGS. 1A, 2A and 3A we see dual ratchet wrench 50 comprising a long length center handle 51 and two reversible ratchet heads 70 and 80. In this example, center handle 51 is long enough so that multisockets 60 and 65 can fold approximately inline with each other on the same side of center handle 51 in the stowed positions 60a and 65a, respectively. By minimizing the distance 42 between the folded ends of multisockets 60 and 65, the length of wrench 50 is minimized when stowed (see FIG. 3A positions 70a and 80a). This reduces the ratchet wrench and sockets to a stowed size that can fit in a user's pants pocket. This folding on the same side of center handle 51 is not the minimum folded length for a dual ratchet wrench, but allows the thickness of the stowed wrench to be minimized. In FIGS. 1A and 2A we see that center handle 51 comprises a center handle body 53, a small ratchet attachment end 57a on one end of handle 53 and a large ratchet attachment end 57b on the other end of handle 53. In FIG. 2A we can see that attachment ends 57a and 57b are “Y” shaped and are designed to attach to ratchet heads 70 and 80, respectively. Ratchet attachment end 57a in this example comprises a y-shaped end with a pivot hole 52a drilled through the end for accepting pivot pin 58a. Ratchet attachment end 57b in this example comprises a y-shaped end with a pivot hole 52b drilled through the end for accepting pivot pin 58b. Center handle ends 57a and 57b also defines two friction latches 54a and 54b. Friction latch 54a comprises spring 55a and ball 56a, where spring 55a forces ball 56a against latch ridges 73 on ratchet head 70 and provides a holding force to reduce the tendency of ratchet head 70 to rotate. Friction latch 54b comprises spring 55b and ball 56b, where spring 55b forces ball 56b against latch ridges 83 on ratchet head 80 and provides a holding force to reduce the tendency of ratchet head 80 to rotate. Smaller ratchet head 70 comprises, a housing 71, and housing extension 72, a plurality of latching ridges 73 on the housing extension, a pivot hole 74 drilled through the housing extension for engaging pivot pin 58a, a toggle style ratchet direction selector 76, a ratchet mechanism 77, and a ratchet drive cylinder 78 with a socket connector 78a and a socket release button 75. Ratchet head 70 in this example has a range of motion approximated by arrow 79 which is about one-hundred eighty degrees (see FIG. 1A). In FIGS. 1A and 2A, we see that larger ratchet head 80 comprises, a housing 81, and housing extension 82, a plurality of latching ridges 83 on the housing extension, a pivot hole 84 drilled through the housing extension for engaging pivot pin 58b, a ratchet direction selector 86, a ratchet mechanism 87, a ratchet cylinder 88 with a socket connector 88a and a socket release button 85. Ratchet head 80 in this example has a range of motion approximated by arrow 89 which is about one-hundred eighty degrees. Both ratchet heads 70 and 80 are mounted on the ends of center handle 51 with pivot pins 58a and 58b, respectively, in such a way that socket connectors 78a and 88a point in the same general direction when in operational positions 70c and 80c (multisocket perpendicular to center handle 51).

In FIG. 3A we see dual ratchet wrench 50 where each ratchet head 70 and 80 comprising three functional positions. The first functional position is the stowed position shown by ratchet head positions 70a and 80a. In this stowed position ratchet heads 70 and 80, along with attached sockets 60 and 65 in their stowed positions 60a and 65a, are in their most compact position, and designed to fit in a user's pants pocket. The second position is the operational position, where the ratchet and socket function as they are normally meant to be used, to engage and turn a rotary fastener. One of the operational positions for ratchet heads 70 and 80 are shown by positions 70c and 80c, respectively. During normal use only one of the two ratchet heads is being used in its operational position while the other ratchet head and attached socket is being used as a grip handle. Thus, the third functional position is a handle position which are shown by ratchet head positions 70b and 80b, and attached socket position 60b.

Throughout this patent the term “operational position” or “operational positions” will be used to describe ratchet and/or sockets that are positioned to engage and turn a rotary fastener. In most cases, the disclosed folding dual ratchet wrenches will have many operational positions for both of its ratchets and attached sockets. The same ratchet and socket positions that are used as an operational position in one configuration of the wrench can be a handle position in another configuration. For example, in FIG. 3A, ratchet head position 70b and socket position 60b is an operational position if ratchet head 80 and socket 65 are used as a grip handle in either positions 80a and 65a (screwdriver grip handle position), or positions 80c and 65c (twist grip handle position). If however, ratchet head position 70b and socket position 60b are used as a pistol grip handle position, then ratchet head position 80c and socket position 65c then become an operational position for ratchet head 80 and socket 65. Thus, each ratchet and socket position can have multiple functional positions depending on the position of the other ratchet head and its attached socket. For example, while ratchet head position 80a and socket position 65a can be used as a screwdriver grip handle position as described above, this position is also the stowed position for ratchet head 80 and socket 65. Notice also that positions 80a and 65a are the stowed positions for ratchet head 80 and socket 65, respectively.

In FIGS. 1B, 2B and 3B we see a second example of a dual ratchet wrench 100 comprising a medium length center handle 101 and two reversible ratchet heads 120 and 130. In this wrench 100 example, center handle 101 is shorter than center handle 51 so that multisockets 61 and 66 can overlap each other when folded into the stowed position 61a and 66a, respectively, to reduce the length of the wrench when stowed (see FIG. 3B) and allow this design to fit in a user's pants pocket and/or fit on a belt clip. In this particular design, the maximum dimension would be measured from the top corner of ratchet head position 120a to the bottom corner of ratchet head position 130a. Notice that shortening handle 101 in this design will reduce the maximum dimension, but only to a point where the sockets define the maximum dimension. In FIGS. 1B and 2B we see that center handle 101 comprises a center handle body 103, with y-shaped attachments ends 57a and 57b on each end of center handle 101 and can be the same as attachments ends 57a and 57b seen on center handle 51 on wrench 50. Ratchet heads 120 and 130 can be the same as ratchet heads 70 and 80, respectively. In this example, housings 121 and 131 are different from housings 71 and 81 and have latching grooves 123 and 133, respectively, which allows a wider range of motion shown by arrows 129 and 139 for ratchet heads 120 and 130, respectively. These ranges of motion for ratchet heads 120 and 130 are approximately two hundred degrees in this example. Ratchet heads 120 and 130 are mounted on the ends of center handle 101 with pivot pins 58a and 58b, respectively, in such a way that socket connectors 78a and 88a point in opposite directions when in operational socket use positions 120c and 130c. The internal components of ratchet heads 120 and 130 can be identical to those shown in ratchet heads 70 and 80, respectively. In FIG. 3B, the longitudinal axises of multisockets 61 in position 61a and multisocket 66 in position 66a are nearly parallel to each other in this example. In alternate designs, ratchet heads 120 and 130 can fold sockets 61 and 66 very close to handle 101 and parallel to it, to provide a more compact stowed position.

In FIG. 3B we see dual ratchet wrench 100 where each ratchet head 120 and 130 comprising three functional positions. The first functional position is the stowed position shown by ratchet head positions 120a and 130a and socket positions 61a and 66a. In this stowed position ratchet heads 120 and 130, along with attached sockets 61 and 66 in their stowed positions 61a and 66a, are in their most compact position, and designed to fit in a users pocket. The second position is the operational position, where the ratchet head and socket function as they are normally meant to be used, to engage and turn a rotary fastener. There are actually several operational positions of ratchet heads 120 and 130 with two of those positions shown by positions 120b and 130b, and 120c and 130c, respectively. During normal use only one of the two ratchet heads is being used in its operational position while the other ratchet head and attached socket can be used as a grip handle. Thus, the third functional position is a handle position where the ratchet and attached socket are used as a grip handle by the user. Some of these grip handle positions are shown by ratchet head positions 120a-c and 130a-c, and their respective attached socket positions 61a-c and 66a-c. For a screwdriver grip handle and short grip handle positions ratchet positions 120a or 130a can be used, for a long grip handle position ratchet positions 120b or 130b can be used, and for a crank grip handle and driver grip handle positions ratchet positions 120c or 130c can be used. Dual ratchet wrench 150 seen in FIG. 3C has a similar set of stowed positions, operational positions, and grip handle positions.

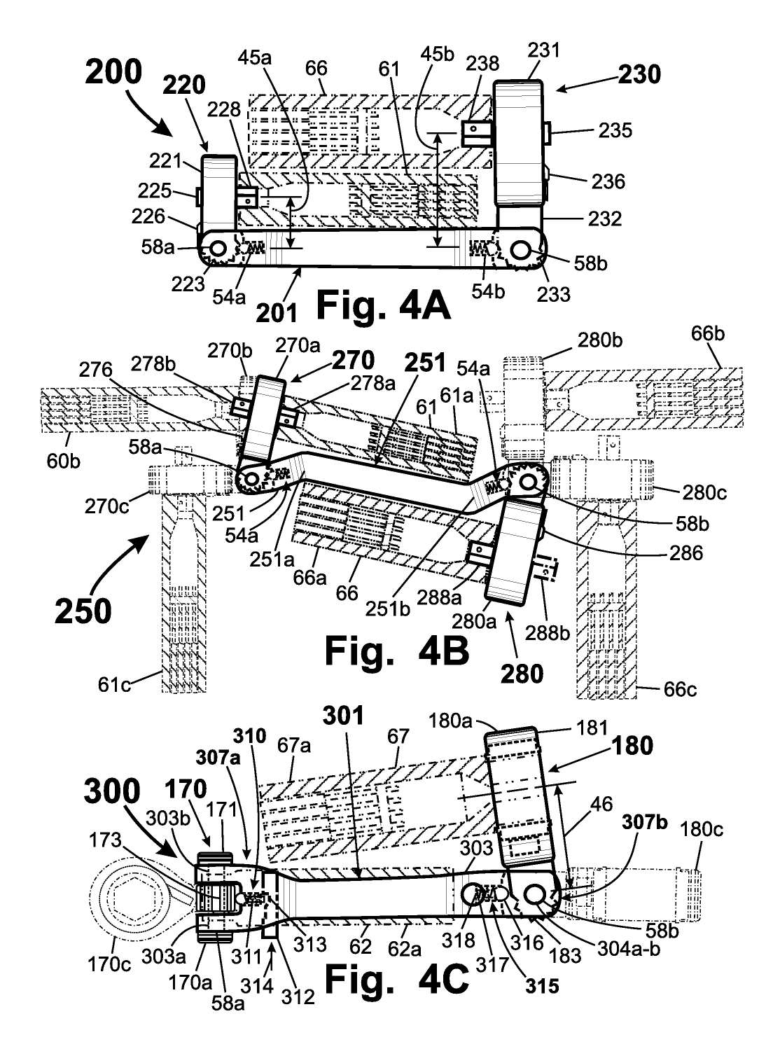

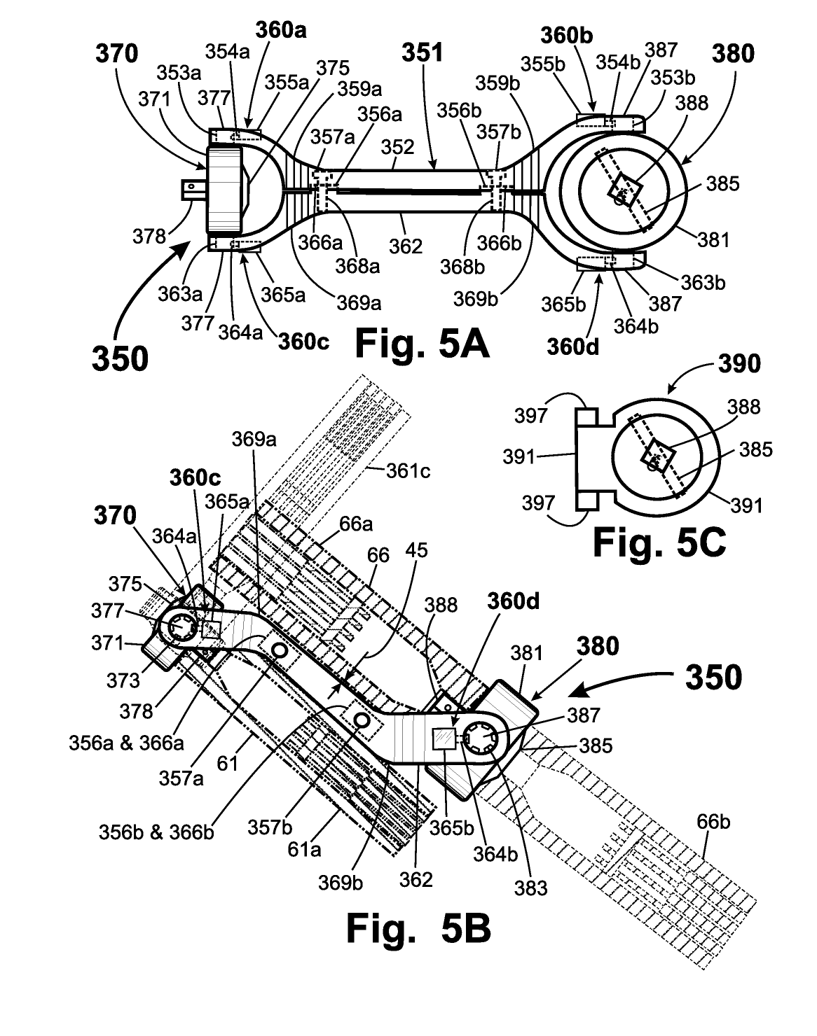

In FIGS. 1C, 2C and 3C we see a third example of a dual ratchet wrench 150 comprising a short length center handle 151 and two reversible ratchet heads 170 and 180. Center handle 151 is significantly shorter than center handle 101 so that multisockets 62 and 67 can nearly completely overlap each other when folded into the stowed positions 62a and 67a, respectively, and minimize the length of wrench 150 when stowed (see FIG. 3C) and allow this design, as well as, the other wrench designs presented here to easily fit in a user's pants pocket and/or fit on a belt clip. The maximum dimension for wrench 150 can be measure from the top corner of ratchet head position 170a to the bottom corner of ratchet head position 180a. Further reduction of the length of center handle 151 can cause the overall stowed length of wrench 150 and multisockets 62 and 67 to be greater since of the stowed positions of multisockets 62 and 67 would begin protruding beyond the ends of center handle 151. Shorter center handle lengths also means a shorter lever arm for the ratchet heads when in use, thus, center handle 151 represents approximately the shortest handle for optimal stowage for the multisocket lengths shown. In FIGS. 1C and 2C we see that center handle 151 comprises a center handle body 153, and attachment ends 57a and 57b. Attachment ends 57a-b are substantially the same as those seen on center handle 51 including the latching assemblies 54a and 54b. Note that many other ratchet attachment end structures exist (see FIGS. 4A and 5A-B), and attachment structures 57a-b are shown in these first three examples (wrenches 50, 100, and 150) only because it is one of the most common pivotal ratchet attachment methods. Ratchet heads 170 and 180 are different from the previous ratchet heads, in that, only a single direction ratchet mechanism is used and the ratchet drive cylinder has been replaced with a drive ring which allows insertion of sockets within ratchet drive rings 178 and 188. Ratchet head 170 comprises, a ratchet housing 171, a set of pivotal ridges 173, a pivot pin hole 174, a bidirectional socket connector surface 176, a single direction ratchet mechanism 177, a ratchet drive ring 178, with a ratchet surface 178a, and a guide surface 178b. Ratchet head 180 comprises, a ratchet housing 181, a set of pivotal ridges 183, a pivot pin hole 184, a bidirectional socket connector surface 186, a single direction ratchet mechanism 187, a ratchet drive ring 188, with a ratchet surface 188a, and a guide surface 188b. Latching grooves 173 and 183 allows a wider range of motion shown by arrows 179 and 189, for ratchet heads 170 and 180, respectively, than ratchet heads 120 and 130, respectively. These range of motion for ratchet heads 170 and 180 is approximately two hundred twenty degrees in this example. Ratchet heads 170 and 180 are mounted on the ends of center handle 151 with pivot pins 58a and 58b. Ratchet heads 170 and 180 can accept multisockets from either direction to allow both tightening and loosening of fasteners with a single direction ratchet.

Ratchet wrenches 100 and 150 not only have ratchet head stowed positions, grip handle positions and socket use operational positions, but can also be used for crank handle operation, which requires the multisockets to point in opposite directions (one as the crank the other for use as the socket) during use. In Crank handle operation one multisocket is gripped by the user as the crank and the other multisocket is used for turning a fastener. This crank handle configuration can be seen in FIG. 3B, with ratchet head position 120c and multisocket position 61c providing a crank handle position, and ratchet head position 130c and multisocket position 66c providing an operational position for engaging and turning a rotary fastener. For wrench 100 this means that ratchet heads 120 and 130 must have the same directional setting (both set to tighten or both set to loosen) to allow proper crank handle operation.

Similarly, ratchet heads 170 and 180, on wrench 150, can use the correct side of socket connectors 176 and 186 to place the ratchet wrench in a position to be used as a crank handle wrench. If the user wants the socket in the crank handle position to ratchet in their hand ratchet mechanisms can be designed to rotation in opposite directions when viewed from the top or bottom (see top view in FIG. 2C). Thus, ratchet mechanisms 177 and 187 cause rotation in opposite directions when the ratchet heads are in their extended position. With multisocket attached in opposite directions one multisocket can be held by the user as a grip handle, while the other multisocket is in an operational position providing rotational torque to turn a fastener. This same ratchet mechanism arrangement can be used in a screwdriver arrangement, but one ratchet head would be used to tighten fasteners and the other ratchet head must be used to loosen fasteners.

In FIG. 4A we see side view of dual ratchet wrench 200 which is similar to ratchet wrench 50 but with both ratchet heads folded for storage on the same side of a center handle 201. Both ratchet heads 220 and 230 are reversible. Ratchets 220 and 230 are designed to overlap their attached multisocket when stowed, as shown. The maximum dimension for this design would be measured from the bottom left corner of center handle 201 to the upper right corner of rachet housing 231. Ratchet wrench 200 comprises a center handle 201, a small ratchet head 220 and a large ratchet head 230. Center handle 201 can be similar to center handle 151 and includes latching assemblies 54a and 54b. Ratchet head 220 comprises a housing 221, a set of latch grooves 223, a socket release button 225, and a reversible ratchet selector 226 (reversible ratchet mechanism itself is not shown), and a socket connector 228 (ratchet drive cylinder not shown in FIG. 4A to retain clarity of drawing, see ratchet drive cylinders 78, 88, 514, 519, and 569). Ratchet head 220 is similar to small ratchet head 70 except that pivot pin 58a is positioned closer to socket connector 228 so that multisocket 61, when connected in its stowed position, rests substantially flush against center handle 201. This shortened pivot axis for ratchet head 220 can also be achieved by using pivot posts similar to pivot posts 387 seen on ratchet head 390 in FIG. 5C. This offset seen in ratchet head 390 can provide the desired multisocket offset seen in ratchet head 220. This small offset type of ratchet head can be used with wrenches 50, 100, 150 and 500 to provide a more compact stowed position, where the multisockets can pivot flat against their ratchet's center handle like ratchet head 220 and multisocket 61 does in FIG. 4A. Ratchet head 230 comprises a housing 231, a ratchet extension 232, a set of latch grooves 233, a socket release button 235, and a reversible ratchet selector 236 (hidden lines for a reversible ratchet mechanism are not shown). Ratchet head 230 is similar to large ratchet head 80 except that pivot pin 58b is further away from socket connector 238 so that multisocket 66, when connected, rests substantially flush against the outer surface of multisocket 61 when stowed as shown in FIG. 4A. Socket connector 228 can be of a different size than socket connectors 238 to prevent the larger multisocket 66 from being used on the smaller ratchet connectors 228 and possible causing damage to the smaller ratchet head 220 with excessive force. The use of two socket connector sizes for socket connectors 228 and 238 also makes the dual ratchet wrench more versatile and durable. The range of pivot motion for ratchet heads 220 and 230 can be similar to those seen in FIGS. 1A through 1C.

In FIG. 4B we see side view of dual ratchet wrench 250 which is similar to ratchet wrench 150, in that, both ratchet heads can removably attach a drive socket on either side of the ratchet wrench and fold for storage on opposite sides of center handle 251. Ratchet wrench 250 comprises center handle 251, a small ratchet head 270 and a large ratchet head 280. Center handle 251 is similar to center handle 101 and includes latching assemblies 54a and 54b. Center handle 251 further comprises two bends 251a and 251b which allows wrench 250 to be folded to a smaller width (smaller distance between the longitudinal axis of multisockets 61 and 66) than seen in wrench 100. Bend 251a allows multisocket 61 to be stowed substantially flush with center handle 251. Similarly, bend 251b allows multisocket 66 to also be stowed substantially flush with center handle 251 for a compact stowed position. Center handle 251 is approximately the same length as center handle 101 so that multisockets 61 and 66 do not completely overlap when stowed. Ratchet head 270 is substantially the same as ratchet head 70 except socket release button 75 has been removed and ratchet drive cylinder 78 is replaced with a drive cylinder with two opposing standard socket connectors 278a and 278b. Socket connectors 278a-b have the same size to allow multisocket 61 to removably attach to either socket connector. Ratchet head 280 is substantially the same as ratchet head 80 except socket release button 85 has been removed and ratchet drive cylinder 88 is replaced with a drive cylinder comprising two opposing standard socket connectors 288a and 288b. Socket connectors 288a-b have the same size to allow multisocket 66 to removably attach to either socket connector. Socket connectors 278a-b can be of a different size than socket connectors 288a-b to prevent the larger multisocket 66 from being used on the smaller ratchet connectors 278a-b to possible prevent damage to the smaller ratchet head 270 with excessive applied force. Also, connectors 278a-b and 288a-b can be different sized socket connectors, such as, connectors 278a-b being ⅜ inch square socket connectors, and connectors 288a-b being ½ inch square socket connectors. Ratchet head 270 is pivotal around the axis of pivot pin 58a from position 270a to 270c and further if desired. Ratchet head 280 is pivotal around the axis of pivot pin 58b with its full range of motion shown by position 270a to 270b. Because of this geometry, all three standard positions for ratchet heads 270 and 280 (stowed positions 270a and 280a, socket positions 270c and 280c, and handle positions 270b and 280b, respectively), can be achieved with or without reversible ratchets. With at least one reversible ratchet, wrench 250 can also provide screwdriver arrangement positions 270b and 280b, and crank arrangement positions 270c and 280c (multisockets facing opposite directions and ratchet selectors 276 and 286 set to the same directional setting). For example, in FIG. 4B, if reversible ratchet control 276 is removed (single direction ratchet) the two ratchets can still provide all possible rotational arrangements by selecting the correct setting for ratchet selector 286 and using the correct socket connector for the desired arrangement (screwdriver or crank handle). However, if socket connector 288b is removed, then ratchet selector 286 is needed to provide both directions of torque to the remaining socket connector 288a. The range of pivot motion for ratchet heads 270 and 280 can be similar to seen in FIG. 1B or 1C.

In FIG. 4C we see side view of dual ratchet wrench 300 with non-planar ratchet pivot axis pins 58a and 58b. Ratchet wrench 300 comprises a center handle 301, a small ratchet head 170 and a large ratchet head 180. Ratchet heads 170 and 180 can be the same ratchets seen on ratchet wrench 150, but can easily be replaced with ratchet heads 120 and 130 from wrench 100, or ratchets like ratchet head 220 with an optimal socket offset. The reader should note that many combinations of the center handles and ratchets are possible besides the different center handles and ratchet heads that are shown as examples in this document. The pivot range of ratchets 170 and 180 in the example in FIG. 4C can be between one hundred eighty and two hundred twenty and allow stowed positions 170a and 180a, socket positions 170c and 180c, and various other positions (not shown). Center handle 301 comprises a center handle body 302, and a pair of y-shaped ends 307a and 307b similar to ends 57a and 57b. Y-shaped end 307a comprises two arms with pivot holes 303a-b and pivot pin 58a for receiving ratchet 170, and a locking latch mechanism 310 which comprises a latch pin 311, a locking pin slide 312, and a release notch 313 on locking slide 312. Y-shaped end 307b comprises two arms with pivot holes 304a-b and pivot pin 58b for pivotally connecting ratchet 180, and a locking latching mechanism 315 which comprises a latch pin 316, a locking slide 317, and a release notch 318 on locking slide 317. Ratchets 170 and 180 are pivotally mounted on ends 307a and 307b with pivot pins 58a and 58b, respectively. Latch pins 311 and 316 engage latching ridges 173 and 183, respectively, because of spring tension. Latch pins 311 and 316 on their opposite ends can engage locking pin slides 312 and 317, respectively. Locking slides 312 and 317 comprise a cylindrical body and a notch 313 and 318, respectively. Locking slide 312, in FIG. 4C, is shown in its unlocked position with latch pin 311 free to move into notch 313 and allow latch pin 311 to move away from ridges 173 and allow ridges 173 to slip pass latch pin 311 when ratchet head 170 is rotated about pivot pin 58a. Slide 312 can be moved as shown by arrow 314 so that notch 313 is moved upward in the drawing and latch pin 311 rides up on a higher point on slide 312 forcing latch pin 311 into a particular ridge 173, locking ratchet 170 in place. In a similar way, latch pin 316, locking slide 317, and notch 318 provide a locking function for ratchet head 180 allowing it to be locked at different angles with respect to center handle 301 for various functions. This engagement between locking slide 312, latch pin 311 and ridges 173, holds ratchet 170 at a fixed angle with respect to center handle 301. Because pivot pins 58a and 58b are at nearly right angles to each other, locking slides 312 and 317 are needed to stabilize ratchet heads 170 and 180, respectively, when they are being used. Without locking slides 312 and 317, ratchet head 170 or 180 would simply pivot in the direction of applied force when being used in a grip handle position. Note that other ratchet wrenches in this patent show the ratchet heads' pivot axises positioned substantially in the same plane with each other, so that torque can be transferred one ratchet head to the other without the need for a locking ratchet pivot joint, as is needed for wrench 300. An out-of-plane misalignment of less than fifteen degrees is desirable for all pivot axises to provide reasonable transfer of torque through the ratchet wrench. Finally, all the example wrenches in this patent can comprise a similar or different locking mechanism on each ratchet head because it is often desirable to be able to lock the ratchet head at a particular angle during use.

In FIGS. 5A and 5B, we see a top view and side view, respectively, of dual ratchet wrench 350. Ratchet wrench 350 comprises, a compound center handle 351, a small center pivot ratchet head 370 and a large center pivot ratchet head 380. Wrench 350 is one of the most compact folding designs disclosed here because the ratchet heads can fold attached multisockets 61 and 66 substantially parallel and substantially flush against the center portion of center handle 351 (see FIG. 5B). Compound center handle 351 comprises a left center handle 352 and a right center handle 362. Left center handle 352 is widened at both ends for connection to ratchet heads 370 and 380. Center handle 352 comprises, a pair of pivot holes 353a-b one on each end of the handle, a pair of indentations 356a-b, a pair of bolts 357a-b, a pair of bends 359a-b on the handle, and a pair of locking latch mechanisms 360a-b comprising a pair of pivot locking pins 354a-b and a pair of locking pin thumb controls 355a-b. Latching mechanisms 360a comprises a pair of pivot locking pins 354a and a pair of locking pin thumb controls 355a. Latching mechanisms 360b comprises a pair of pivot locking pins 354b and a pair of locking pin thumb controls 355b. Right handle 362 has widened ends that are a mirror image of handle 352 for connection of ratchet heads 370 and 380. Handle 362 comprises, a pair of pivot holes 363a-b one on each of the widened handle ends, a pair of stabilizing tabs 366a-b, a pair of bolts 357a-b, a pair of bends 369a-b on handle 362, and a pair of locking latch mechanisms 360c-d. Latching mechanisms 360c comprises a pair of pivot locking pins 364a and a pair of locking pin thumb controls 365a. Latching mechanisms 360d comprises a pair of pivot locking pins 364b and a pair of locking pin thumb controls 365b. The pivot locking pins 354a-b and 364a-b when combined with thumb controls 355a-b and 365a-b, respectively, form two pair of locking latch mechanisms for each ratchet head 370 and 380. When the top and bottom handles 352 and 362 are assembled, tabs 366a-b fit into indentations 356a-b, respectively, to provide added stability for handle 351 during use.

In FIGS. 5A and 5B, small ratchet head 370 comprises a housing 371, multiple locking notches 373 on the circumference of a pair of pivot posts 377, a reversible ratchet selector 375, and a socket connector 378. Large ratchet head 380 comprises a housing 381, multiple locking notches 383 on the circumference of a pair of pivot posts 387, a reversible ratchet selector 385, and a socket connector 388. Ratchet heads 370 and 380 can be a standard and non-standard ratchet head designs. During assembly, ratchet heads 370 and 380 are placed between the two handle sections with round pivot posts 377 fitting snugly into pivot holes 353a & 363a, and pivot posts 387 fitting snugly into pivot holes 353b & 363b to allow pivotal motion of ratchet heads 370 and 380, respectively. Bolts 357a-b fasten handles 352 and 362 together and pivotally hold ratchet heads 370 and 380 in place. Pivot locking pins 354a and 364a engage locking notches 373 on the circumference of pivot posts 377 to lock ratchet head 370 at a specific angle in relation to handle 351. Pivot locking pins 354b and 364b engage locking notches 383 on the circumference of pivot posts 387 to lock ratchet head 380 at a specific angle in relation to handle 351. Thumb controls 355a-b and 365a-b are movable to disengage pivot locking pins 354a-b and 364a-b, respectively, from engagement with pivot post notches 373 and 383, respectively. Ratchet heads 370 and 380 can pivot three hundred sixty degrees to any desired position to provide all five functional positions for the ratchet heads (stowed positions, handle positions, socket use positions, screwdriver positions, and crank handle positions).

In FIG. 5C, we see a top view of alternate ratchet head 390 with modified housing 391. As mentioned previously in the discussion of ratchet head 220 seen in FIG. 4A, pivot posts 377 and 387 can be shifted toward the inside edge of ratchet heads 370 and 380 to allow the desired offset of socket connectors 378 and 388, respectively. In the wrench 350 design (see FIG. 5A), this offset in the stowed position of the socket connectors and multisockets is achieved by bends 359a-b and 369a-b in handles 352 and 362, respectively. However, in FIG. 5C, pivot posts 397 are offset by the shape of housing 391, which moves pivot posts 397 toward the edge of ratchet head 390 to provide the offset from center of pivot posts 397. This offset can be similar to the offset on ratchet head 220 seen in FIG. 4A. Ratchet head 390, because of this offset, can use a substantially straight handle sections instead of the bent handles 352 and 362 seen in wrench 350 and still fold attached multisockets against the handle. Other advantages of this type of offset of pivot posts 387 is: 1) it reduces the maximum width of the ratchet housing compared to ratchet housings 371 and 381 (includes pivot posts 387) and 2) it provides added leverage length when pivoted into position for multisocket use. Both these advantages could be provided without significantly effecting the folded length of such a dual ratchet wrench. Note that the ability of ratchet heads 370 and 380 a full three hundred sixty degrees would be lost unless an oversized space at the ends of the handles were provided. Also note that with multisockets attached ratchet heads 370 and 380 can not rotate a full three hundred sixty degrees.

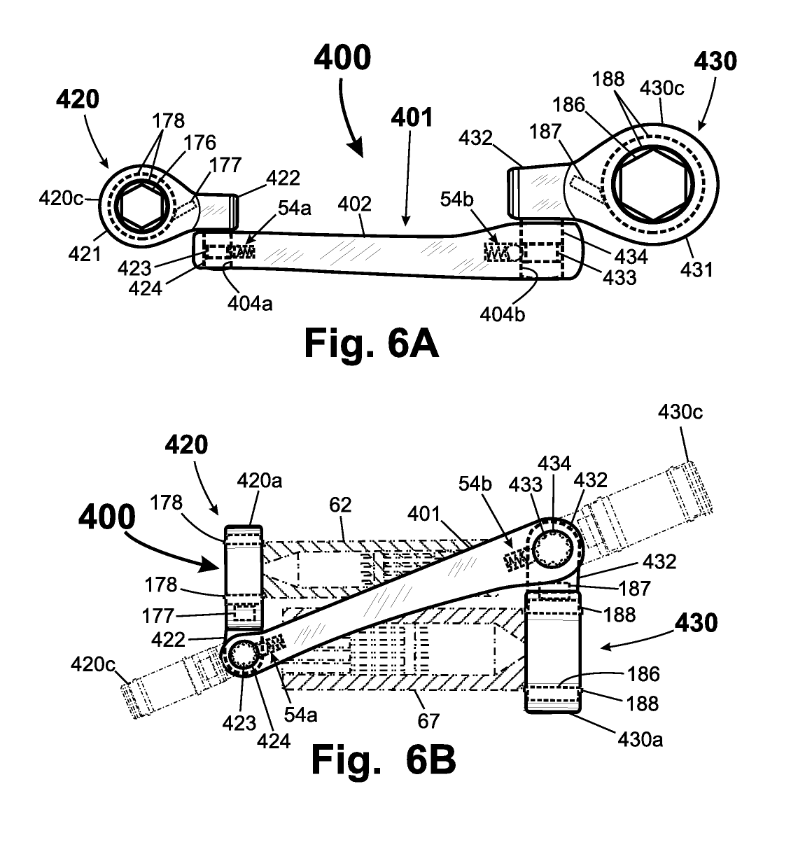

In FIGS. 6A and 6B, we see a top view and side view, respectively, of dual ratchet wrench 400. Wrench 400 comprises, a center handle 401, a small offset pivot ratchet head 420 and a large offset pivot ratchet head 430. Center handle 401 comprises a center handle body 402, and two latching mechanisms 54a and 54b, and two pivot holes 404a and 404b. Latching mechanisms 54a and 54b are similar to those seen in FIGS. 1A-3C and elsewhere. Small ratchet head 420 comprises a ratchet housing 421 comprising a housing extension 422, and a pivot post 424 with a ring of latching ridges 423. Housing 421 supporting previously disclosed ratchet mechanism 177 and drive ring 178 with hexagonal socket connector surface 176. Large ratchet head 430 comprises a ratchet housing 431, comprising a housing extension 432, and a pivot post 434 with a ring of latching ridges 433. Housing 431 supporting previously disclosed ratchet mechanism 187 and drive ring 188 with hexagonal drive socket connector 186. Drive rings 178 and 188 and ratchet mechanisms 177 and 187 can be similar to the drive rings and mechanisms seen in FIGS. 1C, 2C, 3C, and 4C. Pivot posts 424 and 434 are inserted into pivot holes 404a and 404b, respectively. Retaining rings (not shown) can be used to hold the pivot posts in the pivot holes as is common in ratchet tools. Latching mechanisms 54a and 54b engage latching ridges 423 and 433 to provide stable positions for ratchet heads 420 and 430. Ratchet mechanisms 177 and 187 provide single direction rotation for ratchet heads 420 and 430, respectively. The direction of rotation for ratchet mechanisms 177 and 187 are opposite each other in this example so that wrench 400 can be used like a crank wrench where one multisocket faces up for the handle and the other facing downward for the socket. In this way, one multisocket is used as the handle which ratchets freely in the users hand, while the other multisocket is locked and turns the fastening device. Notice that with this design, ratchet heads 420 and 430 can pivot three hundred sixty degrees around their pivot holes 404a-b, respectively, allowing all angles of operational positions. In FIGS. 6A and 6B, wrench 400 is shown with its ratchet heads 420 and 430 inline at positions 420c and 430c. FIG. 6B shows a side view of wrench 400 with ratchet head 420 shown in stowed position 420a and socket use position 420c in shadow lines, and ratchet head 430 is shown in stowed position 430a and socket use position 430c in shadow lines. Ratchet heads 420 and 430 can pivot almost three hundred sixty degrees with multisockets 62 and 67 attached, respectively. Alternatively, center handle 401 could be reshaped so that ratchet heads 420 and 430 can rotate passed the handle for a full three hundred sixty degrees of rotation, to provide many functional geometries.

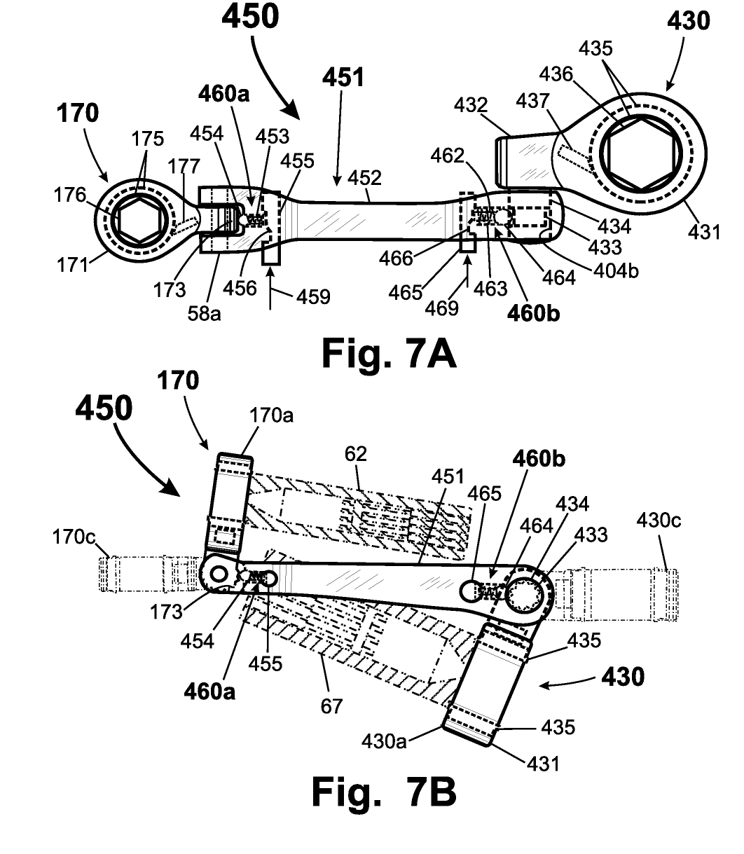

In FIGS. 7A and 7B, we see a top view and side view, respectively, of dual ratchet wrench 450 with one standard pivot ratchet head 470 and one offset pivot ratchet head 480. FIG. 7A shows wrench 450 in its extended crank handle position, while FIG. 7B shows wrench 450 in its stowed position. Wrench 450 is very similar to wrench 400, but only has one offset ratchet head 430. Wrench 450 is an example of how different ratchet head types can be combined. Wrench 450 comprises a center handle 451, the standard style ratchet head 170 seen previously on wrench 150 and the offset style ratchet head 430 first seen in FIG. 6A. Center handle 451 comprises a center handle body 452 with a y-shaped end similar to those seen in FIGS. 2A-C for connecting to ratchet head 170 and a pivot hole 404b similar to that pivot hole seen in FIG. 6A, and two locking latch mechanisms 460a and 460b. Latching mechanism 460a comprises a spring 453, a latching pin 454, a locking slide 455, and a release notch 456. Latching mechanism 460b comprises a spring 463, a latching pin 464 with a latch pin shaft 462, a locking slide 465, and a release notch 466. Springs 453 and 463 are designed to force latching pins 454 and 464 against ridges 173 and 433, respectively, on ratchet heads 170 and 430, respectively, similar to latching mechanisms 54a and 54b seen previously. Latch pins 454 and 464 have similar structure which is more easily seen in latch pin 464 which has its spring 463 cut away to show latch pin shaft 462 which the spring encompasses. When locking slides 455 and 465 are positioned as seen in FIG. 7A, the side of locking slides 455 and 465 force the latching pin 454 and 464, respectively, against latching ridges 173 and 433 to lock ratchet heads 170 and 430 at a particular angle with respect to handle 451. If locking slide 455 is moved in directions 459 from the shown position, then release notch 456 lines-up with the rear portion of latching pin 454 (see latch pin shaft 463 on latch 460b) so that pin 454 can shift into the notch and away from ridges 173 to allow ratchet head 170 to pivot to a new angle with respect to handle 451. Locking slide 465 has similar construction and when moved in directions 469 from the position shown, shaft portion 462 of latching pin 464 lines up with release notch 466 so that pin 464 can shift into notch 466 and allow ridges 433 to slip by latch pin 464 to adjust the position of ratchet head 430 to a new angle with respect to handle 451. When pressed as shown by arrows 459 and 469 locking slides 455 and 465, respectively, slide in that direction and the opposite end of the locking slide protrudes from the handle on the other side. Pressing the locking slides 455 and/or 465 when on the other side of the handle, cause the slides to returned to their original positions shown in FIG. 7A, which locks ratchet heads 170 and/or 430, respectively, at their shown positions. Pivot pin 58a is used to pivotally connect ratchet head 170 to center handle 451, similar to the way ratchet head 170 is attached to center handle 151 in FIGS. 1C, 2C, and 3C and attached to center handle 301 in FIG. 4C. Hole 404b is sized to receive pivot post 434 on ratchet head 430 to provide a pivotal axis. Lock rings or other standard methods can be used to keep ratchet head 430 attached to the center handle. The structure that attaches of ratchet head 430 to handle 451 in FIGS. 7A-B is substantially the same as ratchet head 430 attachment to handle 401 seen in FIGS. 6A and 6B. Thus, handle 451 has the advantage of being able to lock its ratchet heads at a specific angle with latching mechanisms 460a and 460b.

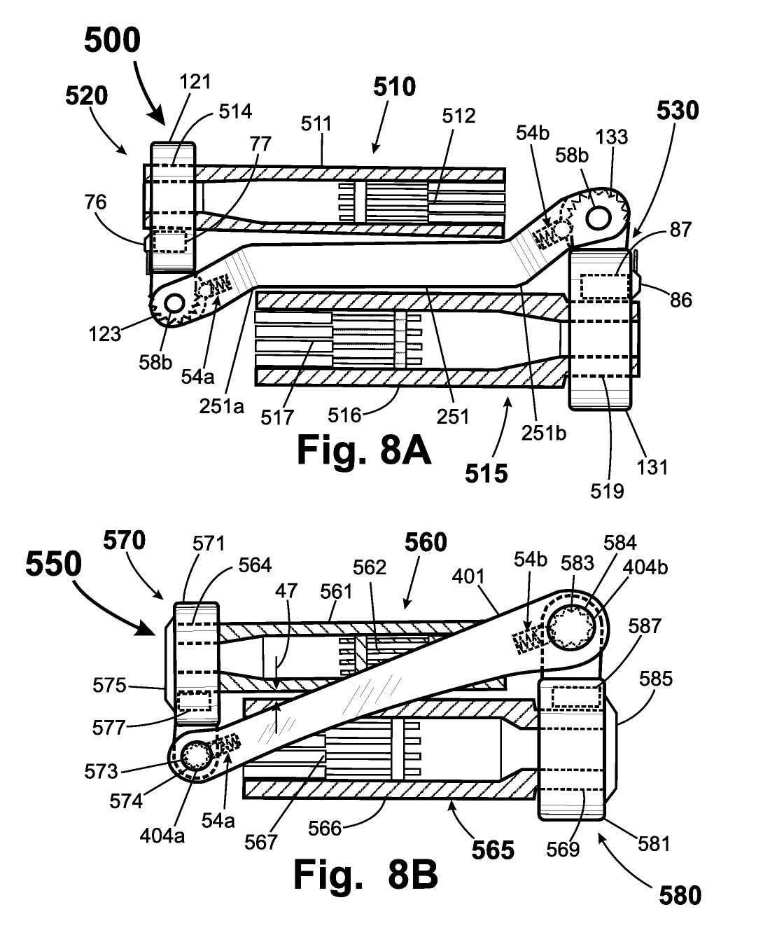

The reader should understand from the above dual ratchet wrench examples that such designs can provide many configurations, with the ratchet positions providing many function for the ratchet heads, including, but not limited to, a stowed position, a grip handle position, a socket use position, a crank grip handle position, and a screwdriver position. It should also be understood that making the grip handle short allows for the ratchet wrench to fold-up into a compact package even with multisockets attached to the ratchet heads. This stowed position with the multisockets is an advantage because the user can have the ratchet wrench and all the socket sizes together in one compact, pocket-friendly, form. In FIGS. 8A and 8B, we see two dual ratchet wrench examples 500 and 550, where the multisockets are permanently attached to the ratchet heads. FIGS. 8A-B show ratchet wrenches 500 and 550 in their stowed position. This final improvement eliminates any chance of separating the ratchet wrench from the multisockets and means the user will always have the socket size they need. I have used two multisockets and two ratchet heads in all of these examples, because a single multisocket is generally too large to get into many spaces where smaller bolts, nuts and screws are placed. Thus, by having two multisockets, each multisocket can have different diameters so they can reach their specific size range and not be oversized for the bolt head, nut head, or other fastener it is being used on. All the ratchet head examples in this patent can have permanently attached multisockets. The two examples, seen in FIGS. 8A and 8B, provide sufficient understanding to someone skilled in tool making to properly engineer an all-in-one ratchet/socket set for each of the disclosed designs and other designs. Building the multisockets into the wrench also allows for the dimensions of the ratchet wrench to be specifically tailored for the multisockets used and thus form the most compact multisocket ratchet wrench sets possible.

In FIG. 8A we see a side view of dual ratchet wrench 500 with two standard style pivot ratchet heads 520 and 530 with permanently attached multisockets 510 and 515, respectively. Ratchet wrench 500 comprises center handle 251 from wrench 250, a small ratchet head 520 connected to small multisocket 510, and a large ratchet head 530 connected to a large multisocket 515. Center handle 251 can be the same as the handle seen in FIG. 4B with a zig-zag shape to allow compact folding of the wrench. Bend 251a allows multisocket 510 to be stowed substantially flush with handle 251. Similarly, bend 251b allows multisocket 515 to also be stowed substantially flush with handle 251 for a compact stowed position. Ratchet head 520 can comprise the outer assembly of ratchet head 120 seen in FIGS. 1B, 2B and 3B, which comprises housing 121, toggle style ratchet selector 76, ratchet mechanism 77, and latching ridges 123 in FIG. 8A. Multisocket 510 is permanently attached to ratchet head 520 and comprises a socket body 511, a multisocket assembly 512, and a ratchet drive cylinder 514 defined on the rear portion of socket body 511. Ratchet drive cylinder 514 replaces drive cylinder 78 from FIGS. 1B, 2B and 3B and provides ratchet drive action directly to socket body 511 to turn multisocket mechanism assembly 512 to provide multiple socket driver sizes in one multisocket. Selector 76 allows reversible operation of ratchet mechanism 77. Ratchet mechanism 77 interacts with the ridged surface of ratchet drive cylinder 514 to provide bi-directional ratchet motion, with the direction of rotation dependent on the position of reversible selector 86 as is common for reversible ratchets.

In FIG. 8A, ratchet head 530 can comprise the outer assembly of ratchet head 130 seen in FIGS. 1B, 2B and 3B, which comprises housing 131, ratchet selector 86, ratchet mechanism 87, and latching ridges 133 in FIG. 8A. Multisocket 515 is permanently attached to ratchet head 530 and comprises a socket body 516, a multi-size socket assembly 517, and a ratchet drive cylinder 519 defined on the rear portion of socket body 516. Ratchet drive cylinder 519 replaces drive cylinder 88 in the examples seen in FIGS. 1B, 2B and 3B and provides ratchet drive action directly to socket body 516 which turns multisocket mechanism assembly 512 to provide multiple socket driver sizes in one multisocket. Selector 76 allows reversible operation of ratchet mechanism 87. Ratchet mechanism 87 interacts with the ridged surface of drive ratchet cylinder 519 to provide bi-directional ratchet motion, with the direction of rotation dependent on the position of reversible selector 86 as is common for reversible ratchets.

In FIG. 8B we see a side view of dual ratchet wrench 550 which is constructed vary similar to dual ratchet wrench 400 seen in FIGS. 6A and 6B. Ratchet wrench 550 comprises, previously discussed center handle 401, a multisocket 560 permanently attached to a small offset pivot ratchet head 570 and a multisocket 565 permanently attached to a large offset pivot ratchet head 580. Center handle 401 can be the same handle used with ratchet wrench 400 and can comprise latching mechanisms 54a-b and pivot holes 404a-b, or other latching systems as desired. Ratchet head 570 comprises a ratchet housing 571, pivot post 574 with a plurality of latching ridges 573, a reversible ratchet selector 575, and a ratchet mechanism 577. Ratchet head 580 comprises a ratchet housing 581, a pivot post 584 with a plurality of latching ridges 583, a reversible ratchet selector 585, and a ratchet mechanism 587. Multisocket 560 is permanently attached to ratchet head 570 and comprises a socket body 561, a multisocket assembly 562, and a ratchet drive cylinder 564 defined on the rear portion of socket body 561. Multisocket 565 is permanently attached to ratchet head 580 and comprises a socket body 566, a multi-size socket assembly 567, and a ratchet drive cylinder 569 defined on the rear portion of socket body 566. Multisockets 560 and 565 can be identical to multisockets 510 and 515, respectively, but are shown here having a slightly different design because ratchet selectors 575 and 585 might require modified socket bodies 561 and 566, respectively. The outer surface of ratchet drive cylinders 564 and 569 act as both the ratchet drive cylinder for ratchet mechanisms 577 and 587, respectively, and the rear portion of socket bodies 561 and 566. Thus, socket bodies 561 and 566 are driven by ratchet drives 564 and 569, respectively, to provide torque to multisocket mechanisms 562 and 567. As with wrench 400, ratchet wrench 550 has the ability to pivot ratchet heads 570 and 580, along with multisockets 560 and 565, a full three hundred sixty degrees for different configurations. Locking latch pin systems similar to locking latch systems 460a and 460b seen in FIG. 7A-B are not shown here to keep the drawing readable, but such locking latch systems can easily be used within handle 401. Note that the size of wrench 550 and 400, can be minimized by reducing the spacing between the sockets and even overlapping them (distance 47 is less than zero) one slightly in front of the other.

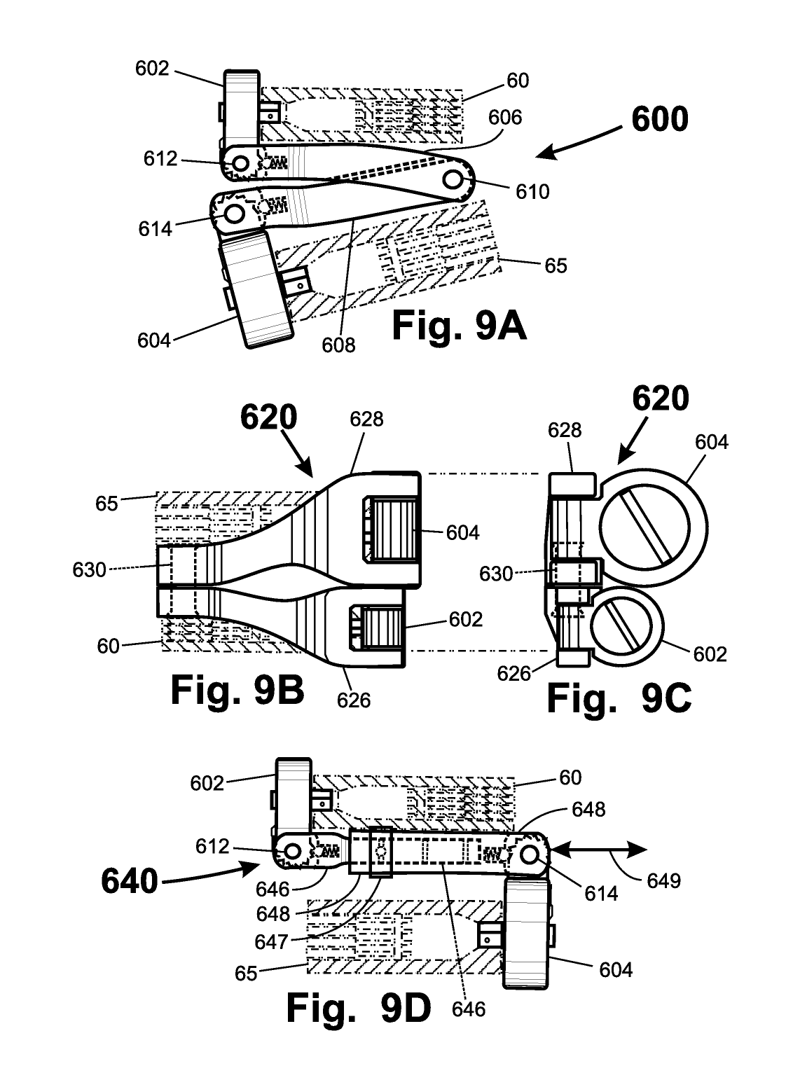

In FIGS. 9A through 9D, we see dual ratchet wrenches 600, 620, and 640 which show two part center handles. Ratchet wrench 600 and 620 shows two styles of folding center handle, and ratchet wrench 640 shows a telescoping center handle. The usefulness of these designs is that it is possible to provide very short and compact dual ratchet wrenches if short length sockets are used.

In FIG. 9A, we see ratchet wrench 600 comprises a small ratchet head 602, a large ratchet head 604, a first center handle segment 606, a second center handle segment 608, and three pivotal hinges 610, 612, and 614. First and second center handle segments 606 and 608 are pivotal around center hinge 610 and are pivotally connected to ratchet heads 602 and 604 with hinges 612 and 614, respectively. Center hinge 610 thus provides a length change means for handle segments 606 and 608. By allowing the center handle to fold as shown, a longer overall center handle can be used, but still fold to a very short length, or overall maximum dimension. If shorter sockets are used, this wrench design can be stow in a small compact space. When folded out, ratchet wrench 600 can function similar to ratchet wrenches 50 and 200, which also place both attached sockets facing the same side of the center handle.

In FIG. 9B-C, we see ratchet wrench 620 comprises a small ratchet head 602, a large ratchet head 604, a first center handle segment 626, a second center handle segment 628, and pivot hinge 630. In FIG. 9B we see a top view of ratchet wrench 620 and in FIG. 9C we see an end view of ratchet wrench 620. In this design, the first and second center handle segments 626 and 628 are pivotally connected at center hinge 630 so that they can fold next to one another, similar to a pair of scissors, for storage, or fold out to an extended length for use. Center hinge 630 thus provides a length change means for handle segments 626 and 628. Ratchet heads 602 and 604 are pivotally connected to the opposite ends of first and second center handle segments 626 and 628, respectively. This particular design, when the center handle segments are folded out, and sockets 626 and 628 face in opposite direction, ratchet wrench 620 can function similar to ratchet wrenches 100, 150, 250, 400, 500 and 550 and provide the similar functional positions.

In FIG. 9D, we see ratchet wrench 640 comprises a small ratchet head 602, a large ratchet head 604, an inner telescoping handle segment 646, an outer telescoping handle segment 648 and a telescoping mechanism 647. Telescoping handle segments 646 and 648 are connected and can include a temporary locking mechanism 647 (telescoping mechanism) to keep the two handle segments fixed at a particular length during use. Such telescoping handles and mechanisms are well known and nearly any prior art telescoping handle design can be used with the disclosed dual ratchet wrench designs. The telescoping handle segments 646 and 648 operate as a length change means for the center handle (handle segments 646, 648, and telescoping mechanism 647). Telescoping handle segments 646 and 648 are pivotally connected to ratchet heads 602 and 604, respectively, with pivot hinges 612 and 614, respectively. Telescoping handle segments 646 and 648 comprise a telescoping mechanism 647 for holding the handle segments at a particular length within the range shown by arrows 649.

### Operational Description

The operation of all the dual ratchet wrenches presented in this patent operate in a way that approximates the operation of a standard ratchet wrench and socket set. Along with this standard operation, the dual ratchet wrenches disclosed here can provide at least eight distinct functional arrangements for the ratchet heads, attached multisocket, and user, that reuse these components for different operational functions. For example, in the presented wrench examples, a folding dual ratchet wrench with attached sockets can have eight distinct functions: 1) a stowed position for storage where both sockets are in their stowed position, 2) a short grip handle position with one socket stowed next to the center handle and the other socket is in a socket use position, or operational position, 3) a long grip handle position with one socket extended to provide maximum torque to the other socket in an operational position, 4) a pistol grip handle position where one socket is extended with its ratchet head providing an offset (one of the long grip handle positions) and the other socket in an operational position (socket use position), 5) a crank grip handle position where the both sockets face in opposite directions and are substantially parallel to each other, 6) a screwdriver grip handle position where one socket is folded against the center handle to provide a grip handle and the other socket extended parallel to the folded socket to engage a rotary fastener, 7) a horizontal grip handle style driver position where one socket is angled approximately perpendicular to the longitudinal axis of the center handle to provide the grip handle and the other socket is angled parallel to the center handle to provide an operational position to engage a rotary fastener, and 8) a socket extension position where one socket is angled parallel to the center handle to get down into tight spaces and the other socket is used as the grip handle. This last configuration is similar to function “7)”, but the user can angle the center handle and grip the grip handle socket more like standard handle. Each of these distinct functional positions have a range of angles for the ratchet heads (and attached multisocket) that allow each function. Each ratchet head can have each of these functional positions. Each ratchet head can have one or more operational positions and one or more handle positions. In any particular operational configuration, one multisocket is used in a handle position while the other is used in the drive socket position, or operational position, to turn a fastener. Because of the pivotal nature of the ratchet heads, many different angled positions can be created for the handle and operational position combinations. These positions can be reversed so the ratchet head and socket that was being used for the handle now becomes the drive socket, and the socket that was being used as the drive socket becomes the handle. In this way, each ratchet head with a multisocket attached has three basic functional types of positions (stowed, grip handle, and driver socket). With these three basic functional positions for the ratchet heads and multisockets, eight distinct functional positions or configurations can be produced: a) a stowed configuration, b) a short handle ratchet wrench configuration, c) a long handle ratchet wrench configuration, d) a long handle configuration with ratchet head and socket providing a pistol grip, e) a crank handle configuration, f) a screwdriver configuration, g) a horizontal handle configuration and h) a socket extension configuration using the center handle as the extension, and for. Each of these functional positions will be discussed in the proceeding sections.

### Ratchet Operation

There are two basic categories of ratchets: 1) reversible ratchets that are switchable between clockwise and counter-clockwise ratchet action, and 2) single direction ratchets or non-reversible ratchets that have a fixed direction of rotation. In each of these categories many different ratchet mechanisms and several examples are shown in this patent. In FIGS. 1A-B, 2A-B, 3A-B, 4A-B, 5A-C, and 8A-B we see reversible ratchet heads 70, 80, 120, 130, 220, 230, 270, 280, 370, 380, 520, 530, 570, 580, 602 and 604. Each of these ratchet heads operate approximately the same, but can have various constructions to provide these operations. For example, ratchet head 70 in FIGS. 1A, 2A, and 3A, is a typical reversible ratchet. Ratchet head 70 defines a ratchet housing 71 that provides support for drive ratchet cylinder 78 with socket connector 75 which allows attachment of a socket or multisocket to the ratchet head. Reversible ratchet mechanism 77 interacts with drive cylinder 78 to allow rotation of drive cylinder 78 in only one direction at a time depending on the selected position of toggle style ratchet selector 76. Thus during operation, drive cylinder 78 can apply a forward torque to socket connector 75 in one direction and then ratchet back freely so that torque can be applied again in the same forward direction. Changing the setting of toggle ratchet selector 76 changes the direction that torque is applied. Generally, clockwise rotation is used to tighten fasteners and counter-clockwise rotation is used to loosen fasteners, but there are exceptions. Ratchet head 70 has extension portion 72 for pivotal attachment to handle 51. Like other pivotal ratches, ratchet head 70, also provide latching function with ridges like ridges 73 and can allow locking the ratchet head in those positions if a locking mechanism is added (see FIG. 7A). Other examples of reversible ratchet heads 370, 380, 390, 570, 580 can be seen in FIGS. 5A-C and 8B. These reversible ratchet heads use a rotary ratchet selector 375, 385, 385, 575, and 585, respectively, instead of the toggle style selector 76, both of which are common constructions for present day ratchets.

This patent also shows examples of non-reversible ratchets (one fixed direction of rotation) being used with the disclosed dual ratchet wrenches. Non-reversible ratchet heads 170, 180, 420 and 430 are shown in FIGS. 1C, 2C, 3C, 4C, 6A-B, 7A-B with only a single direction of rotation. In order to allow both tightening and loosening of fasteners with a single direction ratchets one must allow both sides of the ratchet head to be available for attachment of a socket. Double-sided ratchet heads like ratchet heads 170, 180, 420 and 430 provides the socket with both directions of rotation by alternately attaching the socket to either the front or back of the ratchet head. For example, in FIG. 2C we see ratchet head 180 with ratchet mechanism 187 which only allows drive ring 188 (drive cylinder) to rotate in the counter-clockwise direction as viewed in the drawing. If a socket is connected to socket connector 186 below ratchet head 180 in this drawing, the ratchet head would cause the socket to ratchet in counter-clockwise which only allows the loosening fasteners. However, if ratchet head 180 is flipped over and viewed from the bottom it would appear to have a clockwise rotation and would allow for tightening of fasteners if the socket were attached on the opposite side of the ratchet head. Thus, hex-drive socket connectors 176 and 186 on ratchet heads 170 and 180, respectively, allow sockets to be attached on either side of the ratchet heads, to provide both tightening and loosening of fasteners without the use of ratchet selectors. Similarly, ratchet heads 270 and 280, seen in FIG. 4B, allow the same type of operations by having square style socket connectors 278a-b and 288a-b, respectively, on both sides of the ratchet heads. Note that ratchet heads 270 and 280 are also shown with ratchet selectors 276 and 286 to allow wrench 250 to provide the basic ratchet functions as well as crank handle operation and extended screwdriver operation (discussed in later sections). Thus for this patent, ratchets that have non-reversible ratchet mechanisms require socket connectors on both sides of the ratchet head to provide both tightening and loosening of fasteners with each ratchet head. As with the reversible ratchet heads, many different non-reversible ratchet mechanisms exist and can be used with the disclosed dual ratchet wrenches.

### Stowed Positions (FIGS. 3A-C, 4A-C, 5B, 6B, 7B, and 8A-B)

One of the major advantages of the disclosed dual ratchet wrenches is that they can be stowed with a complete set of socket sizes (multisockets) in a vary compact, pants pocket ready form. Because of this importance of storing compactly, every dual ratchet wrench example in this patent shows the stowed position for its ratchet heads and attached multisockets with “a” after every stowed position label (i.e. 70a, 80a, 120a, 130a, etc.). The stowed position should minimize the overall size of the ratchet heads, center handle and attached sockets. The advantage of providing a compact folding ratchet wrench and a full set of socket sizes can be taken one step further as seen in FIGS. 8A and 8B, where the multisockets are permanently attached to the ratchet heads and therefore cannot be lost. There are three basic folding styles for the example wrenches: 1) folding ratchet heads and multisockets to the same side of the center handle for stowage, 2) folding the ratchet heads and multisockets to opposite sides of the center handle for stowage, and 3) folding one or more ratchet heads and multisockets out of plane with the center handle and/or the other ratchet head for stowage (non-planar configuration).

In FIGS. 1A, 2A, 3A, and 4A, we see examples of a wrenches where the ratchet heads and multisockets fold to the same side of the center handle for stowage. In FIG. 3A, we see wrench 50, with its stowed position shown by alternate ratchet head positions 70a and 80a, and alternate multisocket positions 60a and 65a shown in shadow lines. Stowage of the ratchet heads and multisockets are on the same side of center handle 51, which makes handle 51 longer than the other wrench handles in this patent. Wrench 50 is the only example presented here which places the multisockets on the same side of the handle for storage, and end to end. Distances 40, 41 and 42 can be minimized to make the stowed wrench and attached multisockets as compact as possible. In a real wrench designs, the distance 40 between handle 51 and the end of multisocket 65 stowed at position 65a (or multisocket 60 stowed at position 60a) can be made very small, as can the average distance 41 between handle 51 and multisocket 60 and 65. Ideally, distances 40 and 41 are less than one inch to allow compact folding when using existing prior art ratchet heads, which generally have an offset pivot that is more than one inch from the socket connector. In optimized designs, ratchet heads 70 and 80 can be shaped so that multisockets 60 and 65 stow substantially flush against handle 51 or at least very close to handle 51. Ratchet heads 70 and 80 can also have a greater pivot range so that the multisockets can angle in toward the handle like ratchet 61 in position 61a seen in FIG. 3B. This makes the overall dimension appear even smaller.

In FIG. 4A, we see another wrench 200 stows both ratchet heads to the same side of its center handle. Ratchet heads 220 and 230 can pivot attached multisockets 61 and 66 to the same side of center handle 201, so that the attached multisockets 61 and 66 overlap each other and provide a very compact socket and ratchet wrench set. The offset distance 45a from pivot pin 58a to socket connector 228 is chosen so that multisocket 61 can fold against handle 201 (or very near contact with handle 201). The offset distance 45b, from pivot pin 58b to socket connector 238 is chosen so that multisocket 66 can fold over and on top of multisocket 61 to provide a compact wrench socket set. Note that this method of folding/overlapping on the same side of the handle produces a much shorter stowed position than we saw with wrench 50. This type of folding is especially helpful if longer multisockets, such as, multisockets 61 and 66, are used to provide a more compact wrench. Wrench 50 uses shorter multisockets 60 and 65 to keep the total length of the end to end sockets within pocket size (generally less than seven inches long).

In FIGS. 1B-C, 2B-C, 3B-C, 4B, 5A-B, and 8A we see examples of dual ratchet wrenches where the ratchet heads and multisockets fold to opposite sides the handle for stowage. In all these examples, the center handle, the ratchet heads, and the multisockets all are substantially centered along the same plane, so that they form a sandwich with the center handle in the middle. In FIG. 3B, we see one example of this, with wrench 100, where the stowed ratchet head positions 120a and 130a are shown with attached multisockets in positions 61a and 66a, respectively (one multisocket on each side of center handle 101). These stowed position is shown in light shadow lines. With ratchet heads 120 and 130 folding on opposite sides of the center handle, distance measurement 41 again shows the average distance of multisocket 61 is from the center handle when stowed. Another measured distance 43 shows the distance between the two multisockets. Both of these distances can be used to determine the wrenches compactness. For example, the distances 41 and 43 between stowed multisockets can be minimized to reduce the width of the showed wrench and multisockets. Distance 43 is minimized when both multisockets can fold flat against the wrenches center handle with distance 41 near zero. The distance 44 shows the distance center handle 101 extends beyond the stowed position of multisocket 61. By reducing the distance 44, the wrench can be made shorter up until the point where distance 44 is equal to zero. If the handle length is reduced further, the wrench length is not reduced because multisocket 66a begins to be pushed beyond the end of center handle 151 on the other end. Wrench 150, seen in FIG. 3C, substantially shows this minimized wrench length state. The other wrenches 250, 350, and 500 stow much the same way with their size minimized by folding attached multisockets against the center handle and reducing the center handle's length to approximately the length of the ratchet head and multisocket combined length (see FIGS. 3C and 5B).

In FIGS. 4C, 6A-B, 7A-B, 8B, and 9A-B we see examples of wrenches where the ratchet heads and center handle fold in different planes, so that the arrangement of center handle, and multisockets form a triangular pattern when viewed from the ends of the wrench in its stowed position. FIG. 4C shows wrench 300, which is a special wrench that not only has ratchet heads and center handle that fold into more than one plane, but also has ratchet head pivots with axises that are not parallel. The other wrenches shown in this document all have parallel ratchet heads' pivot axises so that torque can be transferred from one ratchet head to the other without requiring a locking system for the ratchet head pivot. Wrench 300 provides these locking latch mechanisms 307a and 307b so that torque can be transferred from one ratchet head to the other and ultimately to a socket and then to a fastener. The geometry and placement of the ratchet heads 170 and 180 arrange multisocket 62 off to the side of center handle 301, and multisocket 67 resting on top of both the center handle and the side of socket 62. Wrench 300 can be made more compact by reducing the ratchet head's 180 offset distance 46, so that ratchet head 180 brings socket 67 closer to center handle 301 so that it rests nearly parallel and substantially flush against center handle 301 when stowed. Similar adjustments can be made with ratchet head 170 so that it is more like ratchet head 220.

Wrenches 400, 450, 550, 620 in FIGS. 6A-B, 7A-B, 8B, and 9B-C, respectively, have one or more ratchet heads out of plane with the center handle. Wrench 400 has ratchet heads 420 and 430 which are slightly out of alignment with each other and no single plane can pass through the center of both ratchet heads and center handle 401. Wrench 450 has one ratchet head 170 that is in alignment with center handle 451, and a second ratchet head 430 centered in a different plane than that defined by ratchet 170 and center handle 451. Wrench 550 has a construction very similar to wrench 400, with ratchet heads 570 and 580 which are out of alignment and center handle 401, so that, center handle 401 is not in the plane passing through the center of both ratchet heads.

Short Handle and Socket Use Operation (FIGS. 3a, 3b, 3c)

All the dual ratchet wrenches examples disclosed in this patent can be used as in a short handle position. The shortened handle is provided by folding one of the ratchet heads and attached socket to its stowed position next to the center handle. This stowed rachet head, and socket, next to the center handle provide a large griping surface and forms a shorted handle to turn the other ratchet head. The examples shown in FIGS. 3A through 3C should be sufficient to provide understanding for the other wrenches. Wrench 50 in FIG. 3A shows a shortened grip handle comprising ratchet head 70 pivoted to position 70a and socket 60 pivoted to position 60a, and an operational multisocket 65 at position 60c for turning a fastener. In this position, center handle 51, ratchet head 70 and multisocket 60 provide a shortened handle for drive socket 65 on ratchet head 80 in position 80c. Similarly, wrench 100 in FIG. 3B, shows a shortened handle with ratchet head 120 pivoted to position 120a and along with it multisocket 60 in position 60a. In this position, center handle 101, ratchet head 120, and multisocket 61 provide a shortened handle for drive socket 66 on ratchet head 130 in position 130c. Likewise, wrench 150 in FIG. 3C, shows a shortened handle with ratchet head 170 pivoted to position 170a and along with it multisocket 62 in position 62a. In this position, center handle 151, ratchet head 170, and multisocket 62 provide a shortened handle for drive socket 66 on ratchet head 130 in position 180c.

### Long Handle and Socket Use Operation (FIGS. 3A, 3B, 3C, 4B, and 5A-B)

All the dual ratchet wrenches examples disclosed in this patent can be used as a ratchet wrench and socket combination using a long handle position. Many of the dual ratchet wrenches have several combinations of ratchet head positions that allow socket use. Many of these ratchet head combination operates similar to standard ratchet wrenches except with several possible angled positions for the handle. Attached sockets combine with center handle and ratchet head positioning to provide a wide variety of configurations for the wrench. Thus, the folding nature of the invention means the center handle and the wrench can take many forms and shapes for different work requirements. A few of these different forms and configurations will be discussed in the following specifications.

The disclosed wrenches are designed to have operational use in all positions except the stowed position, and even then, wrench 350 could still be used in its stowed position because the ends of the multisockets are exposed, though this is not one of the preferred socket use positions. Generally, either ratchet head can be used to turn the socket for engaging a fastener, while the other ratchet head and attached socket is used as the handle. The operating positions shown in FIGS. 3A-C, 4B and 5A-B should be sufficient for someone to understand the long handle operation of the other examples.

In FIGS. 3A-C, the ratchet heads are shown in one of their positions for use in the long handle position. The larger ratchet heads 80, 130, and 180 are positioned so that their attached multisockets 65, 66, and 67, respectively, are ready to drive a fastener, and the small ratchet heads 60, 61, and 62 with their attached multisockets are ready to be used as handles. In FIG. 3A ratchet head 70 is shown in position 70b with multisocket 60 attached and ready to be used as a handle. Ratchet head 80 in position 80c is ready to use multisocket 65 to drive a fastener. The user would grip multisocket 60 at position 60b and use it as the handle of the ratchet, while multisocket 65 in position 65c is used to turn the fastener. The ratchet heads operation can be reversed by moving ratchet head 70 to position 70c and ratchet head 80 to position 80b so that multisocket 60, which is attached to ratchet head 70, can be used to drive a fastener and multisocket 65 can be used as the handle.

In FIG. 3B, ratchet head 120 is shown in position 120b with multisocket 61 attached and ready to be used as a grip handle. Ratchet head 130 in position 130c with multisocket 66 at position 66c is ready to drive a fastener. The user can grip multisocket 61 at position 61b and ratchet 120 in position 120b, and use them as the grip handle for the wrench, while multisocket 66 in position 66c is used to turn the fastener. The difference in operation between the same side facing ratchets in wrench 50 and the opposite facing ratchets on wrench 100 is that wrench 50 places ratchet 70 (when being used as a grip handle) higher than center handle 51, while wrench 100 places ratchet 120 lower than its center handle 101. Because both ratchet heads are pivotal, center handles 51 and 101 can be pivoted down or up, respectively, to reverse the approximate positions of multisockets 60 and 61 (small angle differences could remain). Thus, both types could function nearly identically. However, the downward angle of ratchet head position 120b and attached multisocket position 61b provides a pistol like grip where the index finger can wrap around ratchet head 120, while the other fingers wrap around multisocket 61. This provides a very nice grip for wrenches that have opposite facing sockets (see wrenches 100, 150, 200, 250, 350, 400, 450, 500, and 550). In FIG. 3B, another useful configuration is shown with ratchet head and multisocket positions 130c and 66c, respectively, being used as a horizontal grip handle (handle position), and ratchet head position 120e with multisocket 61 attached as a ratchet driven driver socket. Note that many other grip handle and driver positions are possible, and only the major types will be discussed within this document. However, it should be understood that many other configurations exist that will not be discussed because the large number of pivot angle possible for ratchet heads 120 and 130, with ratchet head 120 having several position between positions 120b and 120c, and ratchet head 130 having several positions between positions 130a and 130e. Thus, the number of different configurations is large.

In FIG. 3C, we see nearly the same arrangement for wrench 150 as we saw for wrench 50 in FIG. 1C, except center handle 151 is considerably shorter than center handle 51, and ratchet heads 170 and 180 are non-reversible ratchets, and sockets can be attached on either side of the ratchet heads. Because ratchet heads 170 and 180 only turn in one direction, the user must insert a socket on the correct side of the ratchet heads to either tighten or loosen a fastener. Thus, by switching the position of multisocket 62 in socket connector 176, multisocket 62 can either be in a handle position 62b, or a stowed position 62a, or other positions not shown (see FIG. 3C). Single direction ratchet heads 170, 180, 420 and 430 eliminate the ratchet selector and all operate in substantially the same way. Because of this ability to switch the direction of the multisockets, wrench 150 can take on the form of either wrench 50 or 100. Thus, wrench 150 can pivot socket position 62 to a pistol grip position like that shown in FIG. 3B.

In FIG. 4B, wrench 250, operates similarly to wrench 150. Both can allow socket attachment on both sides of their ratchet heads 270 and 280. Both have approximately the same pivot range for their ratchet heads. In some designs for wrench 250, the two positions 280a and 280b can be at the end of pivot range for ratchet 280, and ratchet 270 can have a similar pivot range on the other side. By providing a stop position 280b, ratchet 280 can somewhat lock in place by not being able to rotate further in the counter-clockwise direction as seen in FIG. 4B. This stop position allows multisocket 66 in position 66b to provide a stable screwdriver function, with center handle 251 and multisocket 61 combining in their stowed position to form a compound grip handle for the ratchet screwdriver (ratchet head 280b and multisocket 66b). In alternative designs, ratchet heads 270 and 280 can be modified by making ratchet selector 276 and socket connector 288b in shadow lines optional, and still retaining the majority of their functionality.

In FIGS. 5A-B, wrench 350, can pivot to all the angles shown in the previous wrenches, plus it has a wider pivot range for ratchet heads 370 and 380. In fact, these ratchet heads can pivot three hundred sixty degrees if no socket is attached to them. Thus, wrench 350 has no problem orienting its ratchet heads to the long grip handle position, where one ratchet head and its attached multisocket is pivoted near parallel with center handle 351 or center handle body 352, and the other ratchet head and multisocket is used as the drive ratchet and socket. The reader should note that wrenches 400, 450, 500 and 550 can be positioned in substantially the same configurations as wrenches 50, 100, 150, and 250 and thus provide similar socket/ratchet handle functions. Also, locking latches 360a-d provide stable angles for the ratchet heads, allowing the user to apply forces in multiple directions without the ratchet heads pivoting uncontrollably on them. Thus, this wrench design is more user friendly since the user can lock it into a particular position and it will stay there. Other designs with only the latching systems 54a-b can slip out of place if enough force is applied to the pivot joint during use. All the wrench designs disclosed in this patent can include a locking system for the ratchet pivots. Another example of a locking wrench is wrench 450 which provides locking latches for the pivot joint on ratchet heads 420 and 430.

### Pistol-Grip Handle Operation (FIGS. 3B, 3C, 4B, 5A-B, 6A-B, 7A-B, and 8A-B)

All wrenches that have opposite side stowage of their attached sockets can be used as a pistol grip style handle. This same opposite side ratchet head storage structure also allows the crank handle position. The pistol grip is formed simply by pivoting the ratchet head and socket to be used as the grip handle to an angle near parallel with the wrenches center handle (long handle position). Socket angle differences of as much as forty-five degrees from parallel can still allows the ergonomic use of the pistol grip depending on orientation of the user and fastener. In FIG. 3B, one pistol grip position shown in dark lines with ratchet 120 and socket 61 positioned as the pistol grip handle, and ratchet 130 and socket 66 as the drive socket. The user would wrap their index finger around the outside of ratchet head 130 like a trigger and their other three fingers and thumb around multisocket 61. This provides a very comfortable pistol grip for the user to apply torque to center handle 101. Notice that the pistol grip position is also the long grip handle position for wrenches 100, 150, 250, 350, 400, 450, 500, and 550.

### Crank Grip Handle Operation (FIGS. 3B, 3C, 4B, 5A-B, 6A-B, 7A-B, and 8A-B)

In the crank grip handle arrangement, one socket acts as a vertical grip handle that, when cranked, turns the other socket. The crank handle operation of wrenches 100, 150, 250, 350, 400, 450, 500, and 550 is made possible by their ratchets' ability to pivot the attached sockets to parallel positions that point the attached sockets in opposite directions. Wrench 100, in FIG. 3B, shows one of its crank grip handle positions with ratchet head positions 120c and 130c and their connected socket positions 61c and 66c, respectively. The user would hold multisocket 61 at position 61c in their hand, with multisocket 66 attached to a fastener at position 66c. The user would then crank socket 61c around socket 66c to turn the fastener. Ratchet selector 86 can adjust ratchet mechanism 87 to either tightening or loosening the fastener. Ratchet selector 76 can adjusted ratchet mechanism 77 to allows socket 61c to ratchet freely in the user's hand so that it does not need to slip in the user's hand as the wrench is rotated. This no slip situation occurs when both ratchet heads are set to the same setting (same direction of rotation as seen from the back of the ratchet head). The other wrenches mentioned above achieve the same function by the user pivoting their ratchet heads and sockets to the same configuration. For example, wrench 150 in FIG. 3C, can provide this configuration by simply pivoting ratchet head 170a and multisocket 62a counter-clockwise until multisocket 62 points vertically upward in the drawing. In this position, multisocket 62 can be used as the crank grip handle and multisocket 67 in position 67c can be used as the drive socket. For multisocket 62 to ratchet in the user's hand, instead of slipping, ratchet heads 170 and 180 should allow rotation in the opposite direction when viewed from the same side of the wrench (see ratchet mechanisms 77 and 87 shown in FIG. 2C).

### Screwdriver Operation (FIGS. 1B&3B, 1C&3C, 3A, 4B-C, 5A-B, 6B, 7A-B, and 8A-B)

All of the wrench designs shown in this patent can be used like a screwdriver if desired (center handle parallel to drive socket). Some screwdriver arrangements are more ergonomic than other, with some having the grip handle portion offset from the driver socket, which only marginally makes them harder to use. In the screwdriver arrangements, both sockets are positioned nearly parallel with each other. Ideally the multisockets are also nearly inline with one another so that the socket being used as the grip handle of the screwdriver does not create a wide orbit around the socket being used as the drive socket. An example of this misalignment can be seen in FIG. 5A-5B with socket 61 as shown and socket 66 in position 66b. Socket 66b is used as the ratchet drive socket and the combination of socket 61 and center handle 351 is used as the grip handle. Also, wrench 50 in FIG. 3A, is another example of an offset grip handle. When ratchet head position 70b and multisocket position 60b provide the ratchet drive and socket, and ratchet head position 80a and multisocket position 65a in combination with center handle 51 provide the screwdriver grip handle. The longitudinal axis of socket 60 at position 60b is not inline with center handle 51 nor multisocket 65 in position 65a. Thus, for this example, the screwdriver grip handle (handle 51, multisocket 65, and ratchet head 80 in position 80a) is not positioned over the operational socket 60. However, if ratchet heads 60 can pivot slightly further clockwise, this offset can be reduced. All the other wrench examples in this patent can use their center handle and stowed socket as a screwdriver grip handle.

Preferably, for screwdriver operation, the drive socket is somewhat inline with the stowed socket and center handle (screwdriver grip handle), where the longitudinal axis of the driver socket (also referred to as driver socket axis) is nearly inline with the stowed socket. We can see this arrangement in FIGS. 3B and 3C. In FIG. 3B, wrench 100 can be moved to a screwdriver position when ratchet 130 is rotated to position 130e with an attached multisocket 66 to provide the drive socket, and ratchet head 120 is at position 120a with attached multisocket 61 at position 61a to provide the screwdriver grip handle. The screwdriver sockets can be reversed when ratchet head 120 is moved to position 120e with attached multisocket 61 providing the drive socket, and ratchet head 130 at position 130a and attached multisocket 66 at position 66a provides the screwdriver grip handle. That is, ratchet head 130 and multisocket 66 are combined at positions 130a and 66a with center handle 101 to provide the screwdriver grip handle. This arrangement substantially aligns the screwdriver grip handle (multisocket 60a and handle 101) with the drive socket (multisocket 61 on ratchet head at position 120e), though not exactly inline. In FIG. 3C, wrench 150 can be placed in a screwdriver position by rotating rachet head 180 ninety degrees counter-clockwise so that it is almost inline with multisocket 62 in position 62a. Then multisocket position 62a and center handle 151 can be gripped by the user to provide a easily griped screwdriver handle for drive ratchet 180 which is now nearly parallel to center handle 151.

### Horizontal Grip Operation (FIGS. 3A-C, 4B, 5A-B, 6A-B, 7A-B, and 8A-B)

An ergonomic horizontal style grip handle that is partially centered with the drive socket can be formed with wrench designs 100, 150 200, 350, 400, 450, 500, and 550 disclosed in this patent. The attached sockets or multisockets are positioned to form a T-shaped structure with one socket acting as the horizontal grip handle and the other socket being used as the ratcheted driver socket. This configuration is shown in FIG. 5B, where ratchet 370 is pivoted so that multisocket 61 is at position 61c and multisocket 66 at position 66b is used as the drive socket. The other examples can pivot their ratchet heads and attached sockets to produce approximately the same configuration. For example in FIG. 3B, wrench 100 is shown with ratchet head 120 and multisocket 61 positioned to provide a pistol-grip style handle (position 61c). If ratchet head 130 is pivoted counter-clockwise to position 130e, multisocket 66 now becomes the drive socket. The user can grip socket 61 with three fingers and a thumb while their index finger folds around ratchet head 120 for a very ergonomic grip for turning ratchet head 130 and multisocket 66. Notice that in this configuration, ratchet head 120 and multisocket 61 are substantially centered with the centerline of ratchet 130 in position 120e. This allows the user to simply twist their wrist to drive ratchet head 130 and multisocket 66. Dual ratchet wrenches 100, 150, 250, 350, 400, 450, 500, and 550 can be positioned into this T-shaped horizontal grip handle position with either of their ratchet heads. Some wrench examples can center the horizontal grip handle (ratchet head and socket) better than others, depending on the offset of their ratchet heads.

Some of the wrench examples in this patent do not center the drive socket's longitudinal axis through the horizontal grip handle because the ratchet heads cannot pivot their attached sockets to the opposite sides of their center handle (see wrenches 50, 200, and 300). Without this arrangement, the ratchet heads and attached sockets are positioned off to one side of the drive socket's longitudinal axis (also referred to as drive socket axis). Even with this offset of the drive sockets when the sockets are positioned perpendicular to each other, the wrench can still be used as a horizontal grip handle style wrench by gripping the horizontal socket in substantially the same way. For example, wrench 50 in FIG. 3A, is one example of an offset grip handle, where ratchet head position 70b and multisocket position 60b provide the ratcheted drive socket, and ratchet head position 80c and multisocket position 65c provide the horizontal grip handle. The longitudinal axis of socket 60 at position 60b does not intersect with multisocket 65 in position 65c, but is still usable. The user can grip ratchet head 80 and multisocket 65 and twist them to turn drive socket 60. However, if both ratchet heads 70 and 80 can be pivoted slightly further clockwise, this offset can be reduced as the longitudinal axis of multisocket 60 moves closer to multisocket 65. Also note that this arrangement uses center handle 51 as a socket extension that can allow socket 60 to reach deep into a piece of equipment to reach a bolt, nut or other fastener. All the wrench examples in this patent can use their center handle as a socket extension similar to wrench 50.

### Center Handle Used as Socket Extension (see FIGS. 3A-C)

While all the dual ratchet wrenches disclosed here can use their center handle as a socket extension, the examples shown in FIGS. 3A-C should provide sufficient examples to understand the other wrench styles. Wrench 50 in FIG. 3A, is already shown in a configuration where center handle 51 can be used as a socket extension. In FIG. 3A, ratchet 70 and socket 60 provide the ratcheted socket driver while ratchet 80 and socket 65 provide the grip handle (handle position). In this configuration, socket 60 can extend deep into equipment with the help of handle 51. Wrench 100 in FIG. 3B, shows ratchet 120 and socket 61 extended far away from ratchet head 130 and socket 66 being used as the grip handle. Again the wrench 100 can extend deep into equipment because of the length of center handle 101. Wrench 150 in FIG. 3C, shows ratchet 170 and multisocket 62 ready to be used as a socket driver and rachet 180 and multisocket 67 ready to be used as a grip handle. Center handle 151 provides an extension for the wrench though shorter than both wrenches 50 and 100. The other wrench examples in this patent can also use their center handles to provide an extension for either ratchet and its attached sockets.

### RAMIFICATIONS, AND SCOPE

The disclosed dual pivotal ratchet wrench provides a ratchet wrench that when combined with multisocket technology, provides an pivot ratchet with extension and a full set of socket sizes that folds into a very compact tool that can fit in a user's pocket. The wrench itself has a center handle that is relatively short compared to most standard ratchet wrenches, but when a socket is connected to each ratchet, one socket acts as a grip handle extension and provide grip for the user. The geometry of the design can comprise folding the ratchet heads to the same side of the center handle (FIGS. 1A, 2A, 3A, and 4A), folding the ratchet heads to the opposite sides of the center handle (FIGS. 1B-C, 2B-C, 3B-C, 4B, 5A-B, and 8A), and folding one ratchet head out of the plane formed by the other ratchet head and center handle (FIGS. 4C, 6A-B, 7A-B, and 8B). These structures provide five distinct functional modes depending on the positioning of the ratchet heads: 1) a stowed position for storage, 2) a socket use position with a short handle, 3) a socket use position with a long handle, 4) a socket use position with a pistol grip handle, 5) a socket use position with a crank handle, 6) a socket use position with a screwdriver like handle, 7) a socket use position with a horizontal handle style driver, and 8) a socket use position with the center handle used as a socket extension.

Although the above description of the invention contains many specifications, these should not be viewed as limiting the scope of the invention. Instead, the above description should be considered illustrations of some of the presently preferred embodiments of this invention. For example, it should be obvious from the above discussion that the wrench examples in FIGS. 1A through 9D can be used with standard single-size drive sockets. Multisockets are preferred in the examples because they provide greater functionality for the dual ratchet wrench. Other embodiments can comprise additional pivots placed between the ends of the center handles to provide additional folding of the wrench. Also many different center handle shapes can be used for various ergonomic reasons and the center handle shapes shown here are only examples of the many shapes possible. The reader should further understand that all the disclosed dual ratchet wrenches can comprise locking mechanisms for the ratchet pivots with similar function to locking latch mechanisms 310, 315, 360a-b, 360c-d, 460a and 460b seen in FIGS. 4C, 5A-B, and 7A-B. The various ratchet mechanisms 77, 87, 177, 187, 437, etc. are shown as examples of some of the standard ratchet head designs that can be used. The type of ratchet mechanism used is not particularly important to the invention, and nearly any prior art ratchet mechanism design can be used with the disclosed invention.

Thus, the scope of this invention should not be limited to the above examples, but should be determined from the following claims.

1. A ratchet wrench, comprising:
a) a center handle having a first end and a second end,
b) a first ratchet head pivotally connected to the first end of the center handle with a first pivot hinge, and a second ratchet head pivotally connected to the second end of the center handle with a second pivot hinge;
c) wherein the first ratchet head comprises a first elongated socket connector designed for removably connecting a first elongated socket to the ratchet wrench, wherein the second ratchet head comprises a second elongated socket connector designed for removably connecting a second elongated socket to the ratchet wrench;
d) wherein the first and second ratchet heads and attached first and second elongated sockets are pivotal to a stowed position, wherein the first and second elongated socket are longitudinally overlapped when in the stowed position, whereby a user can place the ratchet wrench and attached first and second elongated sockets in a pants pocket when in the stowed position.
e) wherein the first and second elongated sockets are each pivotal to a handle position, wherein when one of the ratchet heads and attached elongated socket define a grip handle in the handle position the other ratchet head and elongated socket is usable in an operational position to engage and turn a rotary fastener.

2. The ratchet wrench in claim 1, wherein the attached first and second elongated sockets are substantially parallel to a longitudinal axis of the center handle when in the stowed position, wherein the maximum dimension in the stowed position is less than seven inches, less than six inches, less than five and one-half inches, and/or less than five inches.

3. The ratchet wrench in claim 1, wherein the first and second elongated sockets each comprise a multisocket which are permanently attached to the first and second ratchet heads, respectively, whereby the multisockets are part of the ratchet wrench.

4. (canceled)

5. (canceled)

6. The ratchet wrench in claim 1, wherein the first and second elongated socket connectors are defined on both a front and a back portions of their respective ratchet head, whereby the first elongated socket can be attached to either the front or back portion of the first ratchet head, and the second elongated socket can be attached to either the front or back portion of the second ratchet head.

7. The ratchet wrench in claim 1, further including a first and second locking mechanism in combination with the first and second ratchet heads, respectively, for temporarily locking the first and/or second ratchet heads in a fixed pivotal position with respect to the center handle.

8. The ratchet wrench in claim 1, wherein the center handle comprises a first and second center handle portions, wherein the combination of the first and second center handle portions further comprises a length change means for allowing the user to substantially reduce the length of the center handle for stowage.

9. The ratchet wrench in claim 1, wherein the first and second ratchet heads are designed to pivot the first and second elongated sockets, respectively, to a substantially adjacent position next to the center handle.

10. The ratchet wrench in claim 1, wherein the first and second ratchet heads are designed to pivot the first and second elongated sockets, respectively, to a substantially flush position against a portion of the center handle.

11. The ratchet wrench in claim 1, wherein the center handle is shaped to allow the first and second ratchet heads to pivot the first and second elongated sockets, respectively, to a substantially flush position against a portion of the center handle, whereby the ratchet wrench and sockets define a more compact stowed position.

12. A ratchet wrench, comprising:
a) a center handle having a first end and a second end,
b) a first ratchet head pivotally connected to the first end of the center handle, and a second ratchet head pivotally connected to the second end of the center handle;
c) wherein the first ratchet head is designed for removably connecting a first elongated socket to the first ratchet head, wherein the second ratchet head is designed for removably connecting a second elongated socket to the second ratchet head;
d) wherein the first and second ratchet heads are pivotal to a first and second stowed position, respectively, wherein the first and second stowed positions longitudinally overlap the first and second elongated sockets when the elongated sockets are attached to their respective ratchet head.

13. The ratchet wrench in claim 12, wherein the first and second stowed positions position the first and second elongated sockets on opposite sides of the center handle, when attached to their respective ratchet head.

14. The ratchet wrench in claim 12, wherein the maximum dimension for the ratchet wrench in the stowed position is less than seven inches, less than six inches, less than five and one-half inches, and/or less than five inches.

15. The ratchet wrench in claim 12, wherein the first and second multisockets are permanently attached to the first and second ratchet heads, respectively, whereby the elongated sockets are part of the ratchet wrench.

16. The ratchet wrench in claim 12, further including a first and second locking mechanism in combination with the first and second ratchet heads, respectively, for temporarily locking the first and/or second ratchet heads, respectively, in a fixed pivotal position with respect to the center handle.

17. The ratchet wrench in claim 12, wherein the center handle comprises a first and second center handle portions, wherein the combination of the first and second center handle portions further comprises a length change means for allowing the user to substantially reduce the length of the center handle for storage, whereby the length change means is defined by either a center hinge or a telescoping assembly.

18. The ratchet wrench in claim 12, wherein the first and second ratchet heads are designed to pivot the first and second elongated sockets, respectively, to a substantially flush position against a portion of the center handle.

19. The ratchet wrench in claim 12, wherein the center handle is shaped to allow the first and second ratchet heads to pivot the first and second elongated sockets, respectively, to a substantially flush position against a portion of the center handle, whereby the ratchet wrench and elongated sockets can be folded to a more compact stowed position.

20. The ratchet wrench in claim 12, wherein the first and second ratchet heads define different elongated socket sizes.

21. A ratchet wrench, comprising:
a) a center handle having a first end, a center hinge and a second end, wherein the center handle defines a fully extended position and a folded position, wherein the first and second ends are pivotable around the center hinge to a substantially adjacent position with respect to each other when in the folded position, whereby the ratchet wrench can fit in a user's pants pocket;
b) a first ratchet head pivotally connected to the first end of the center handle with a first pivot hinge and designed for attachment of a first elongated socket, and a second ratchet head pivotally connected to the second end of the center handle with a second pivot hinge and designed for attachment of a second elongated socket;
c) wherein the first ratchet head can pivot the first elongated socket to at least one stowed position, at least one operational position, and at least one handle position;
d) wherein the second ratchet head can pivot the second elongated socket to at least one stowed position, at least one operational position, and at least one handle, position.

22. The ratchet wrench in claim 21, wherein the length of the center handle is less than five inches, less than four and one-half inches, less than four inches, less than three and one-half inches and/or less than three inches when the first and second ends are pivoted substantially adjacent to each other.
